(19) United States
(12) Patent Application Publication
(10) Pub. No.: US 2009/0022079 A1
(43) Pub. Date: Jan. 22, 2009

(54) Method and apparatus for providing enhanced channel interleaving

(76) Inventors: Fei Frank Zhou, San Diego, CA (US); Yan Wang, San Jose, CA (US); Panayiotis Papadimitriou, Tewksbury, MA (US); Zhouyue Pi, San Diego, CA (US)

Correspondence Address: DITTHAVONG & MORI, P.C., Suite A, 10507 Braddock Road, Fairfax, VA, 22032, US

(21) Appl. No.: 11/415,447

(22) Filed: May 1, 2006

Related U.S. Application Data
(60) Provisional application No. 60/680,285, filed on May 12, 2005.
(60) Provisional application No. 60/677,495, filed on May 4, 2005.

(51) Int. Cl. H04H 20/71

(52) U.S. Cl. 370/312

(57) ABSTRACT

An approach is provided for channel interleaving. A plurality of symbols are received and partitioned into a plurality of subblocks. The subblocks form a plurality of subsequences. A first output sequence is generated from the subsequences. The subsequences of the first output sequence is selected and punctured to generate a second output sequence, and interleaving the second output sequence.

### RELATED APPLICATIONS

This application claims the benefit of the earlier filing date under 35 U.S.C. §119(e) of U.S. Provisional Application Ser. No. 60/680,285 filed May 12, 2005, entitled “Enhanced Channel Interleaver For Supporting Communication Services,” and U.S. Provisional Application Ser. No. 60/677,495 filed May 4, 2005, entitled “Method and Apparatus for Code Puncturing and Channel Interleaving”; the entireties of which are incorporated by reference.

### FIELD OF THE INVENTION

The invention relates to communications, and more particularly, to providing more particularly to channel interleaving.

### BACKGROUND OF THE INVENTION

Radio communication systems, such as cellular systems (e.g., spread spectrum systems (such as Code Division Multiple Access (CDMA) networks), or Time Division Multiple Access (TDMA) networks), provide users with the convenience of mobility along with a rich set of services and features. This convenience has spawned significant adoption by an ever growing number of consumers as an accepted mode of communication for business and personal uses. To promote greater adoption, the telecommunication industry, from manufacturers to service providers, has agreed at great expense and effort to develop standards for communication protocols that underlie the various services and features. One key area of effort involves broadcast and multicast services. Development of transmission standards, notably in the area of channel interleaving, has not adequately provided for such broadcast and multicast services.

Therefore, there is a need for an approach to provide a channel interleaving scheme that is optimized for broadcast and multicast services.

### SUMMARY OF THE INVENTION

These and other needs are addressed by the invention, in which an approach is presented for channel interleaving in a communication system that provide, for example, broadcast and multicast services.

According to one aspect of an embodiment of the invention, a method comprises receiving a plurality of symbols. The method also comprises partitioning the symbols into a plurality of subblocks. The subblocks form a plurality of subsequences. Additionally, the method comprises generating a first output sequence from the subsequences. Further, the method comprises selecting the subsequences of the first output sequence and puncturing the first output sequence to generate a second output sequence, and interleaving the second output sequence.

According to another aspect of an embodiment of the invention, an apparatus comprises a symbol reordering module configured to receive a plurality of symbols and to partition the symbols into a plurality of subblocks. The apparatus also comprises a subblock repetition module configured to repeat the subblocks. The subblocks form a plurality of subsequences. The subblock repetition module is further configured to generate a first output sequence from the subsequences. Additionally, the apparatus comprises a sequence selection and punctuation module configured to select the subsequences of the first output sequence and to puncture the first output sequence to generate a second output sequence. Further, the apparatus comprises a matrix interleaving module configured to interleave the second output sequence.

According to another aspect of an embodiment of the invention, a method comprises encoding a plurality of signals as encoded symbols, and scrambling the encoded symbols. The method also comprises interleaving the scrambled symbols. The step of interleaving includes reordering the encoded symbols, wherein the encoded symbols are sequentially distributed into a plurality of subblocks. The step of interleaving also includes performing repetition of the subblocks, wherein the subblocks are formed into subsequences. Also, the step of interleaving includes performing selection and punctuation of the subsequences, and applying a matrix interleaving scheme to the symbols associated with the selected and punctured subsequences. Further, the method comprises modulating the interleaved symbols as modulated signals, and transmitting the modulated signals.

According to yet another aspect of an embodiment of the invention, a system comprises an encoder configured to encode a plurality of signals as encoded symbols. The system also comprises a scrambler configured to scramble the encoded symbols, and a channel interleaver configured to interleave the scrambled symbols. The channel interleaver is configured to perform the step of reordering the encoded symbols, wherein the encoded symbols are sequentially distributed into a plurality of subblocks. Additionally, the channel interleaver is configured to perform the step of performing repetition of the subblocks, wherein the subblocks are formed into subsequences. Further, the channel interleaver is configured to perform the step of performing selection and punctuation of the subsequences, and applying a matrix interleaving scheme to the symbols associated with the selected and punctured subsequences. Further, the system comprises a modulator configured to modulate the interleaved symbols as modulated signals.

Still other aspects, features, and advantages of the invention are readily apparent from the following detailed description, simply by illustrating a number of particular embodiments and implementations, including the best mode contemplated for carrying out the invention. The invention is also capable of other and different embodiments, and its several details can be modified in various obvious respects, all without departing from the spirit and scope of the invention. Accordingly, the drawings and description are to be regarded as illustrative in nature, and not as restrictive.

### BRIEF DESCRIPTION OF THE DRAWINGS

The invention is illustrated by way of example, and not by way of limitation, in the figures of the accompanying drawings in which like reference numerals refer to similar elements and in which:

FIG. 1 is a diagram of the architecture of a wireless system capable of supporting various aspects of broadcast-multicast services, in accordance with an embodiment of the invention;

FIG. 2 is a diagram of a transmit chain for supporting broadcast-multicast services;

FIG. 3 is a diagram of a transmit chain including a puncturer/channel interleaver for supporting broadcast-multicast services, in accordance with an embodiment of the invention;

FIG. 4 is a flowchart of a process for channel interleaving, in accordance with an embodiment of the invention;

FIG. 5 is a diagram of a scheme for symbol reordering, according to an embodiment of the invention;

FIG. 6 is a flowchart of a process for providing subblock repetition, in accordance with an embodiment of the invention;

FIG. 7 is a flowchart of a process for providing sequence selection and punctuation, in accordance with an embodiment of the invention;

FIG. 8 is a diagram of an exemplary payload utilized in the process of FIG. 4, according to an embodiment of the invention;

FIG. 9 is a diagram of a puncturing scheme utilized in the process of FIG. 4, according to an embodiment of the invention;

FIGS. 10A and 10B are diagrams of exemplary payload constructions utilized in the process of FIG. 4, according to an embodiment of the invention;

FIG. 11 is a flowchart of a process for matrix interleaving, in accordance with an embodiment of the invention;

FIGS. 12A-12F are graphs showing the performance of the puncturer/channel interleaver of FIG. 3;

FIG. 13 is a diagram of hardware that can be used to implement various embodiments of the invention;

FIGS. 14A and 14B are diagrams of different cellular mobile phone systems capable of supporting various embodiments of the invention;

FIG. 15 is a diagram of exemplary components of a mobile station capable of operating in the systems of FIGS. 14A and 14B, according to an embodiment of the invention; and

FIG. 16 is a diagram of an enterprise network capable of supporting the processes described herein, according to an embodiment of the invention.

### DESCRIPTION OF THE PREFERRED EMBODIMENT

An apparatus, method, and software for providing channel interleaving in a communication system are described. In the following description, for the purposes of explanation, numerous specific details are set forth in order to provide a thorough understanding of the invention. It is apparent, however, to one skilled in the art that the invention may be practiced without these specific details or with an equivalent arrangement. In other instances, well-known structures and devices are shown in block diagram form in order to avoid unnecessarily obscuring the invention.

Although the present invention is discussed with respect to a radio communication network (such as a cellular system), it is recognized by one of ordinary skill in the art that the present invention has applicability to any type of communication systems, including wired systems. Additionally, the various embodiments of the present invention are described with respect to Turbo codes; however, it is contemplated these embodiments are applicable to other coding schemes (e.g., convolutional and/or block codes).

By way of example, a radio network operates according to the Third Generation Partnership Project 2 (3GPP2) standard for supporting High Rate Packet Data (HRPD), in particular, Enhanced Broadcast-Multicast (EBCMCS). Enhanced Broadcast-Multicast (EBCMCS) has been proposed for 1xEV-DO, which introduced Orthogonal Frequency Division Multiplexing (OFDM) modulation to combat a multi-path fading channel. The present invention, according to various embodiments, improves performance of EBCMCS systems. A more detailed description of the HRPD and EBCMCS is provided in 3GPP2 C30-20040607-060, entitled “Enhanced Broadcast-Multicast for HRPD,” June 2004; 3GPP2 C30-20040823-060, entitled “Detailed Description of the Enhanced BCMCS Transmit Waveform Description,” August 2004; and TSG-C.S0024-IS-856, entitled “cdma2000 High Rate Packet Data Air Interface Specification”; all of which are incorporated herein by reference in their entireties.

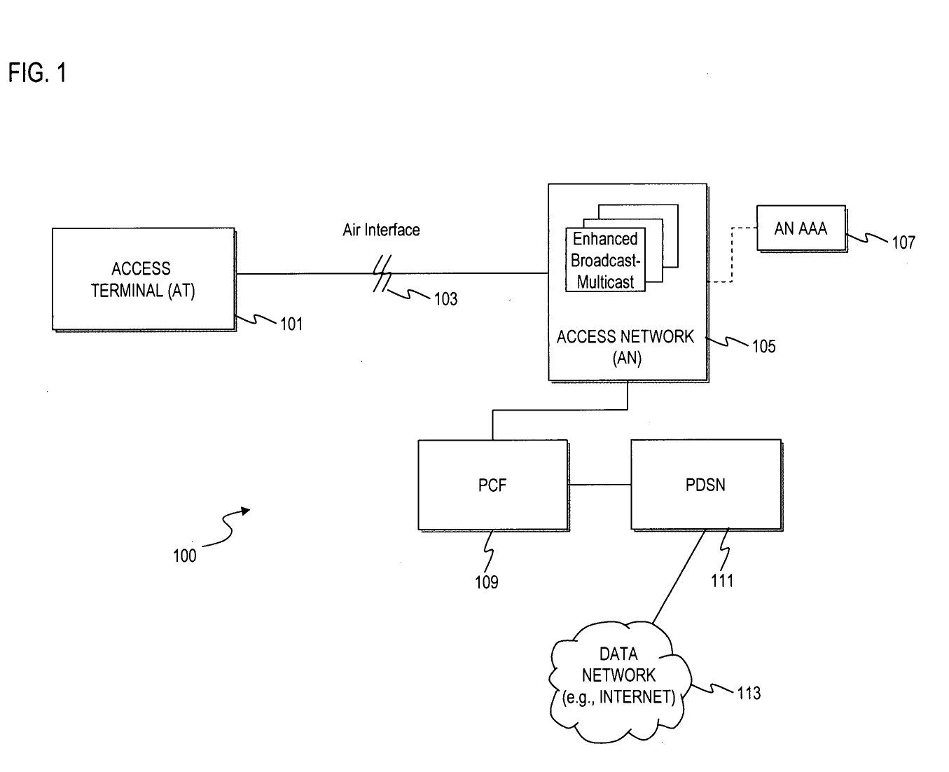

FIG. 1 is a diagram of the architecture of a wireless system capable of supporting various aspects of broadcast-multicast services, in accordance with an embodiment of the invention. The radio network 100 includes one or more access terminals (ATs) 101 of which one AT 101 is shown in communication with an access network (AN) 105 over an air interface 103. The AT 101 is a device that provides data connectivity to a user. For example, the AT 101 can be connected to a computing system, such as a personal computer, a personal digital assistant, and etc. or a data service enabled cellular handset. As more fully described below, the AT 101 employs a transmit chain that includes a channel interleaver that, in various aspects of the invention, factors in the broadcast-multicast services.

The AN 105 is a network equipment that provides data connectivity between a packet switched data network, such as the global Internet 113 and the AT 101. In cdma2000 systems, the AT 101 is equivalent to a mobile station, and the access network is equivalent to a base station.

The AN 105 communicates with a Packet Data Service Node (PDSN) 111 via a Packet Control Function (PCF) 109. Either the AN 105 or the PCF 109 provides a SC/MM (Session Control and Mobility Management) function, which among other functions includes storing of HRPD session related information, performing the terminal authentication procedure to determine whether an AT 101 should be authenticated when the AT 101 is accessing the radio network, and managing the location of the AT 101. The PCF 109 is further described in 3GPP2 A.S0001-A v2.0, entitled “3GPP2 Access Network Interfaces Interoperability Specification,” June 2001, which is incorporated herein by reference in its entirety.

In addition, the AN 105 communicates with an AN-AAA (Authentication, Authorization and Accounting entity) 107, which provides terminal authentication and authorization functions for the AN 105.

Both the CDMA2000 1xEV-DV (Evolutionary/Data and Voice) and 1X EV-DO (Evolutionary/Data Only) air interface standards specify a packet data channel for use in transporting packets of data over the air interface on the forward link and the reverse link. A wireless communication system may be designed to provide various types of services. These services may include point-to-point services, or dedicated services such as voice and packet data, whereby data is transmitted from a transmission source (e.g., a base station) to a specific recipient terminal. These services may also include point-to-multipoint (i.e., multicast) services, or broadcast services, whereby data is transmitted from a transmission source to a number of recipient terminals.

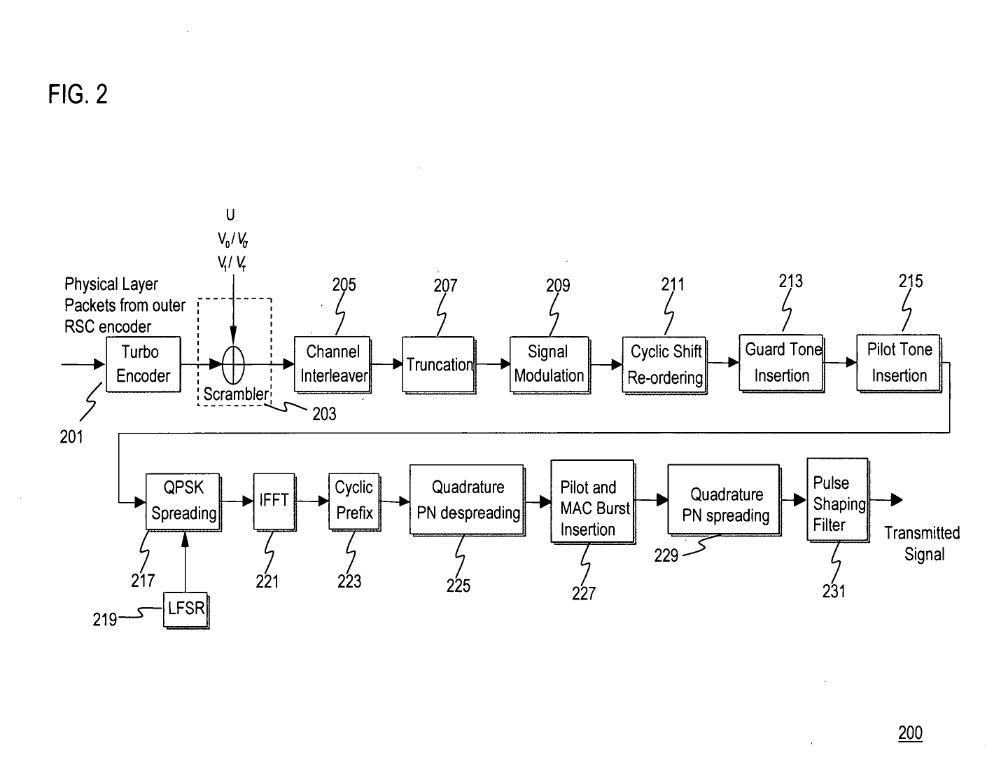

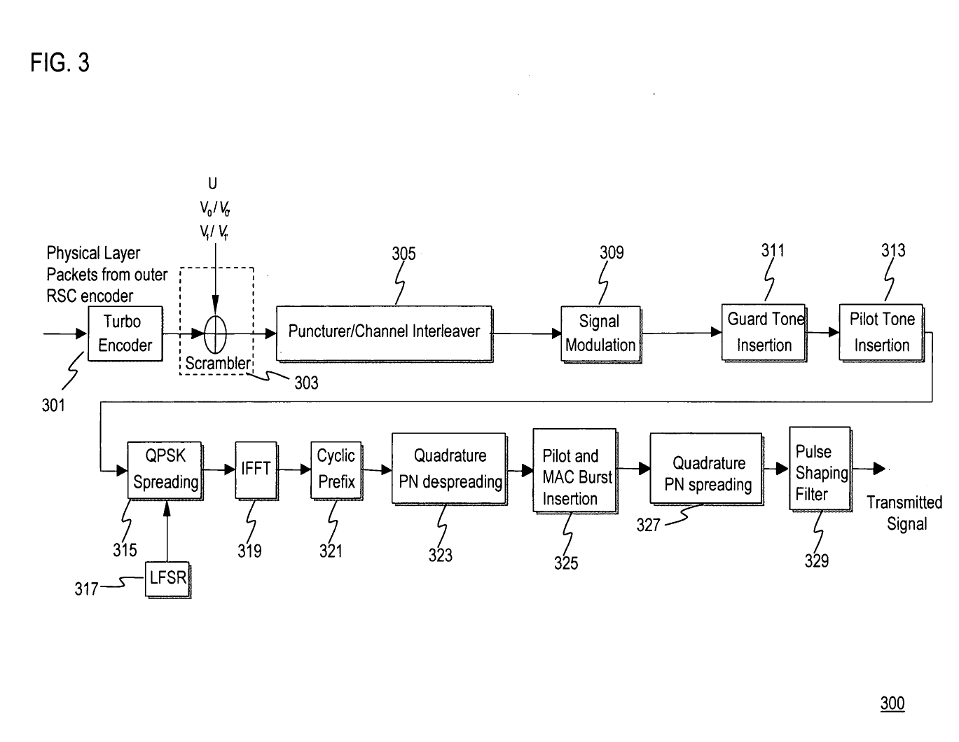

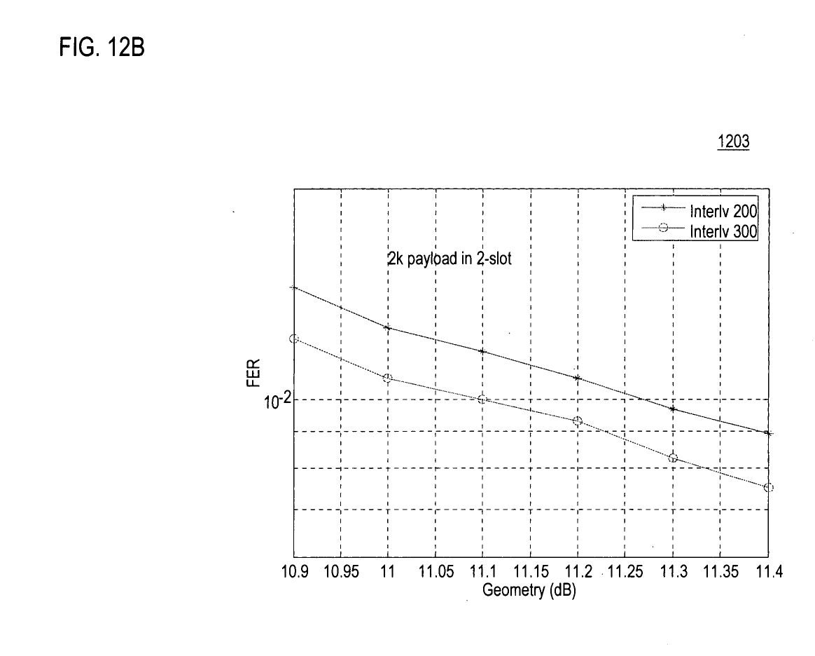

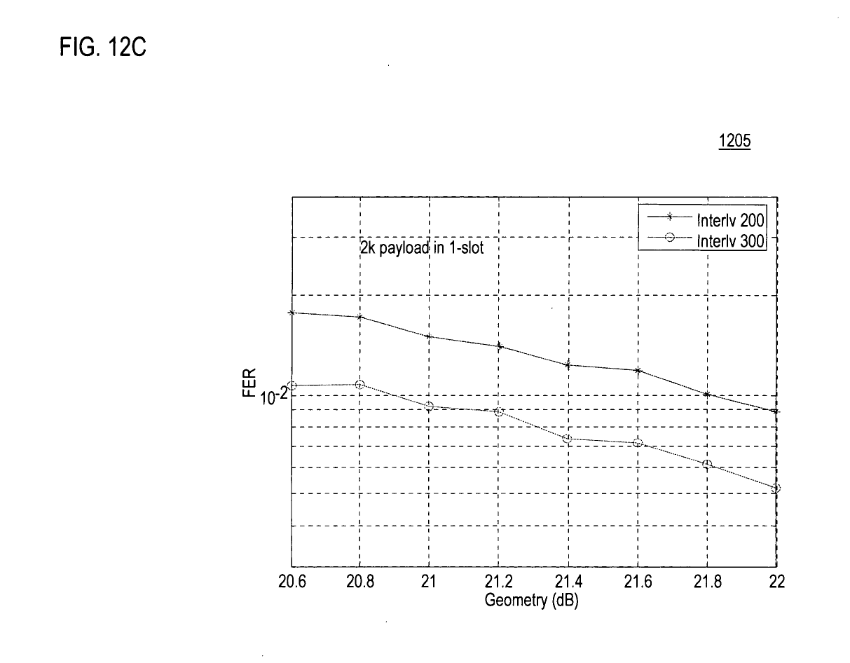

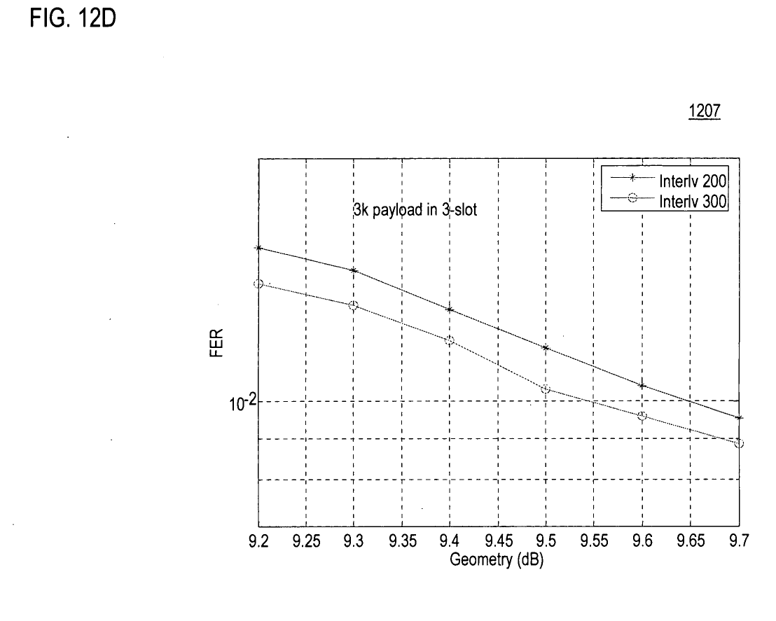

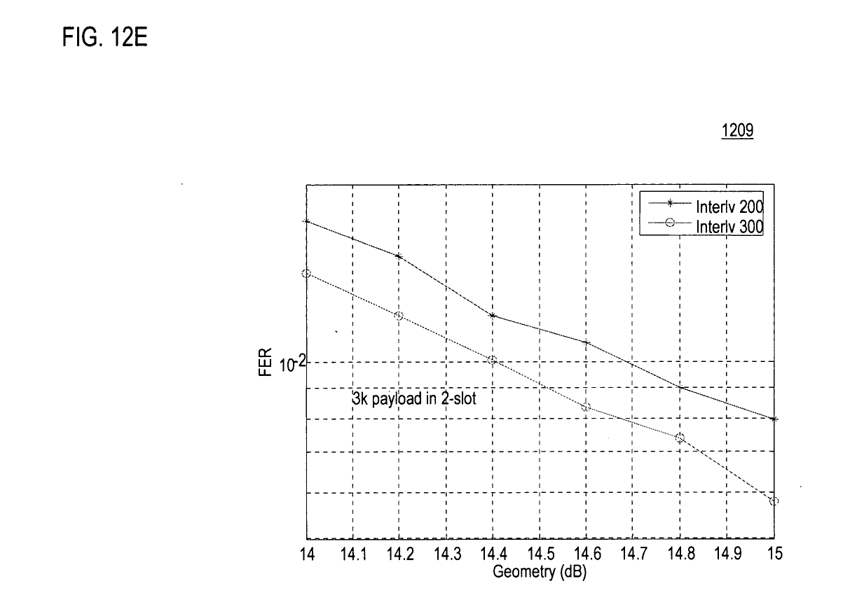

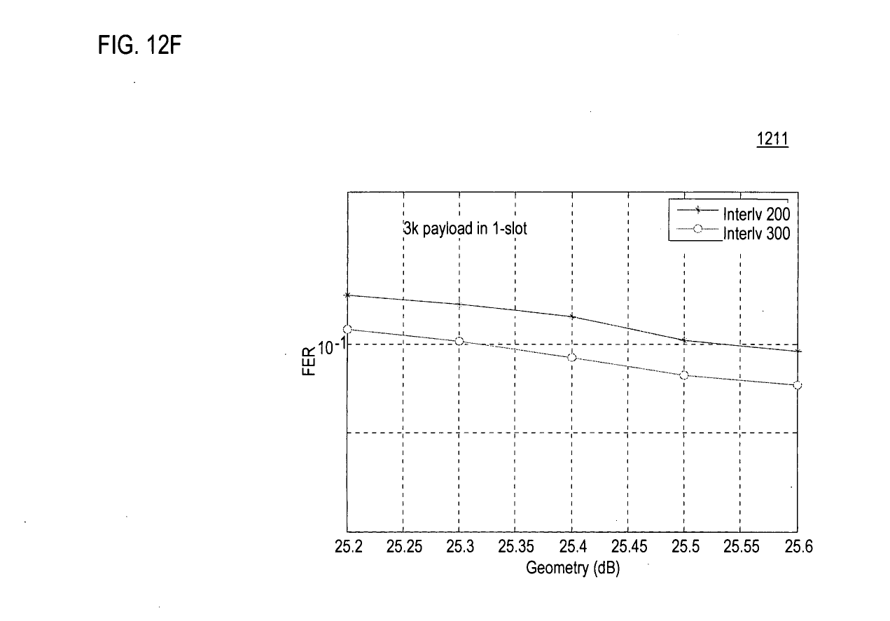

One approach for transmitting signals over the communication system 100 is to utilize a terminal with a transmit chain of FIG. 2. This transmit chain is illustrated to provide a baseline for comparison with the transmit chain of FIG. 3; the performance of which are depicted in FIGS. 12A-12F.

FIG. 2 is a diagram of a transmit chain for supporting broadcast-multicast services. A transmit chain 200 supports Enhanced Broadcast-Multicast (EBCMCS), which employs Orthogonal Frequency Division Multiplexing (OFDM) modulation. The EBCMCS physical layer packets are Turbo encoded with code rate R=1/5 by a Turbo encoder 201. The Turbo encoder 201, in an exemplary embodiment, is used in conjunction with an outer code, such as Reed-Solomon (RS) code. The scrambler 203 scrambles the encoder output, which is then channel interleaved by the channel interleaver 205, repeated if necessary, and truncated by the truncation module 207 to accommodate different data rates from 409.6 kbps to 1.8432 Mbps. The truncated sequence is then mapped by the modulator 209. The data rates achieved by six different modulation coding schemes (MCS) of EBCMCS are given in Table 1 below.

TABLE 1

| Rate set 1 (3072 payload) | | | Rate set 2 (2048 payload) | | |
|---|---|---|---|---|---|
| | # of | | | # of | |
| Data Rate | slots | Index of MCS | Data Rate | slots | Index of MCS |
| 1.843 M | 1 | 6 | 1.228 M | 1 | 3 |
| 921.6k | 2 | 5 | 614.4k | 2 | 2 |
| 614.4k | 3 | 4 | 409.6k | 3 | 1 |

To achieve better performance, a cyclic shift re-ordering process 211 is introduced after modulation. The process of inserting guard tones are implemented next by the insertion module 213, followed by the pilot tone insertion by the pilot tone insertion module 215 into the signal.

After 16-QAM (Quadrature Amplitude Modulation) modulation, there are 240 16-QAM modulated data symbols per symbol block, which, together with 64 Quadrature Phase Shift Keying (QPSK) pilot symbols and 16 guard symbols, constitute one OFDM block with 320 tones. Following frequency domain QPSK spreading by spreader 217—attached to a Linear Feedback Shift Register (LFSR) 219 that supplies the PN sequences, Inverse Fast Fourier Transform (IFFT) time domain data symbols are obtained by the IFFT module 221.

After adding cyclic prefix (CP) by the cyclic prefix module 223 and Pseudo-Noise (PN) de-spreading using Quadrature PN dispreading module 225, time domain data symbols are time-multiplexed with the pilot and Medium Access Control (MAC) channels by multiplexer 227 in accordance with TSG-C.S0024-IS-856, with the IS-856 traffic channel being replaced by the Enhanced Broadcast Multicast (EBM) traffic channel (as detailed in C30-20040823-060).

Further, the time-multiplexed signal is slot-interlaced (if it is a multi-slot transmission), quadrature PN spread by module 229, and base-band filtered by the pulse shaping filter 231. The result signal is then transmitted over the air interface 103.

Traditionally, the scheme of channel interleaver 205 and truncation module 207 is exactly the same as that in 1xEV-DO (TSG-C.S0024-IS-856), i.e., the subblocks of systematic bits U, parity bits V₀/V₀′ and V₁/V₁′, are interleaved separately, and the truncation module 207 provides certain puncture patterns for parity bits while the systematic bits are kept and transmitted always in the first slot.

The channel interleaver 205 is designed in favor of HARQ (Incremental Redundancy) for unicast transmission. For broadcast-multicast scenario, such a constraint does not exist; the design of the channel interleaver of FIG. 3 recognizes this fact, and thus, optimizes transmission for this scenario.

FIG. 3 is a diagram of a transmit chain including a puncturer/channel interleaver for supporting broadcast-multicast services, in accordance with an embodiment of the invention. In transmit chain 300, Turbo encoding, via a Turbo encoder 301, is utilized as in the example of FIG. 2; the encoded signals are Turbo encoded with an outer RS code and scrambled by the scrambler 303. Under this approach, a puncturer/channel interleaver 305 replaces the channel interleaver 205 and truncation module 207 of the system of FIG. 2. Also, no cyclic shift re-ordering is employed with the transmit chain 300. In one embodiment, the transmit chain 300 implements 309 and 311-329 modules that correspond to the modules 209 and 213-231.

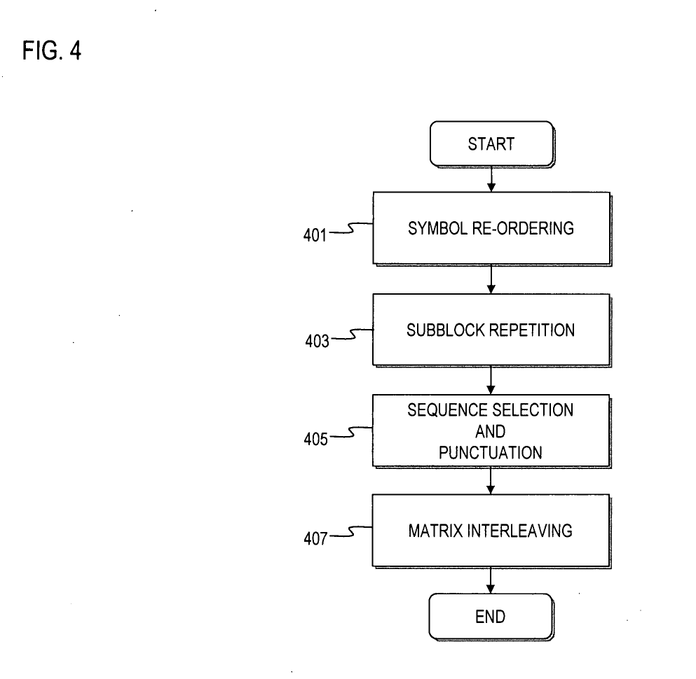

The single interleaver 305 operates on both systematic and parity bits, and offering time diversity gain for systematic bits in the presence of fast fading channel as well as more interleaver gain due to the larger interleaver size. According to various embodiments, the channel interleaver 305 utilizes four stages of processing—i.e., symbol reordering, subblock repetition, sequence selection and punctuation, and matrix leaving (as shown in FIG. 4).

In an exemplary embodiment, for Rate Set (RS) 1, 2, or 5, the output of the Turbo encoder 301 is scrambled and demultiplexed into five subblocks denoted as S, P₀, P₀′, P₁, P₁′, each of the length N (N=3072 for RS1 or RS5, N=2048 for RS2). For RS3 or 4, the output of the Turbo encoder 301 can be scrambled and demultiplexed into three subblocks denoted as S, P₀, P₀′; each of the length N (N=5120 for RS3, N=4096 for RS4).

In this example, a higher order modulation scheme, such as 16-QAM modulation is adapted. As such, four consecutive symbols are grouped to form a 16-QAM modulation symbol. If the required number of modulation symbols exceeds the number modulation symbols at a previous stage, the first few symbols of the modulation symbol sequence is repeated; otherwise, the output of the previous stage is truncated.

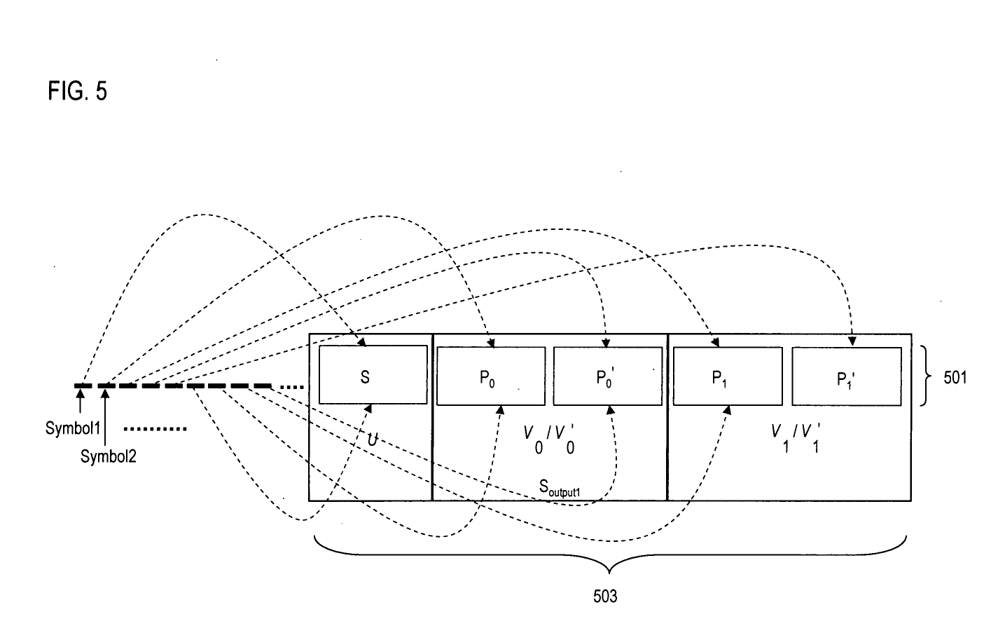

FIG. 4 is a flowchart of a process for channel interleaving, in accordance with an embodiment of the invention. In general, the channel interleaver 305 first, as in step 401, re-orders the encoded symbols. Next, the interleaver 305 performs subblock repetition (step 403), followed by sequence selection and punctuation (step 405). Lastly, matrix interleaving is performed. These processes are detailed below in FIGS. 5-11.

FIG. 5 is a diagram of a scheme for symbol reordering, according to an embodiment of the invention. The symbol reordering stage 401 reorders the symbols at the output of the Turbo encoder 301. The output of the Turbo encoder 301 can be demultiplexed into, for example, subblocks 501. For the purposes of explanation, five subblocks are employed and denoted by S, P₀, P₁, P₀′ and P₁′. Namely, the encoder output symbols can be sequentially distributed into five subblocks with the first symbol going to the S subblock, the second to the P₀ subblock, the third to the P₁ subblock, the fourth to the P₀′ subblock, the fifth to the P₁′ subblock, the sixth to the S subblock, etc.

The S, P₀, P₁, P₀′ and P₁′ subblocks can form three subsequences 503, named U, V₀/V₀′, and V₁/V₁′. The subsequence U includes the subblock S; the subsequence V₀/V₀′ includes the subblock P₀ followed by the subblock P₀′; the subsequence V₁/V₁′ includes the subblock P₁ followed by the subblock P₁′.

The output sequence Sₒᵤₜₚᵤₜ₁ of this stage includes three subsequences: U subsequence, followed by V₀/V₀′ subsequence, and followed by V₁/V₁′ subsequence. Letting Nₒᵤₜₚᵤₜ₁=N_{payload}/R denote the length of the output sequence, for the modulation coding schemes listed in Table 1, R=1/5, N_{payload}=3042 or 2048 for Rate 1 and 2, respectively.

Sequence reorganization and symbol reordering is summarized, in Table 2:

TABLE 2

```
If RS3
    Define integers M₁ = 2M − N, M₂ = 3M − N
Else
    Define integers M₁ = M − N, M₂ = min (2N, 2M − N),
    If 2M − 3N > 0,
        M₃ = 2M − 3N
    Else
        M₃ = 3M − 3N
Compute index sets:
S₁ = {└N/M₁┘ + round(i*2N/M₁)|0 ≦ i < M₁},
S₂ = {└N/M₂┘ + round(i*2N/M₂)|0 ≦ i < M₂} − S₁,
S₃ = {i|0 ≦ i < 2N} − S₁ − S_{2,}
S₄ = {└N/M₃┘ + round(i*2N/M₃)|0 ≦ i < M₃},
S₅ = {i|0 ≦ i < 2N} − S₄.
S₁ − S₂ denotes the set difference operation.
Order the subsequences as follows:
U, W₀(S₁), W₀(S₂), W₀(S₃), W₁(S₄), W₁(S₅) for RS1, 2, or 5
U, W₀(S₁), W₀(S₂), W₀(S₃) for RS3, or 4
U is set to S.
Sequence W₀, is formed by concatenating P₀ and P₀′.
Sequence W₁, is formed by concatenating P₁ and P₁′.
```

After re-ordering of the symbols, subblock repetition is performed, as next explained.

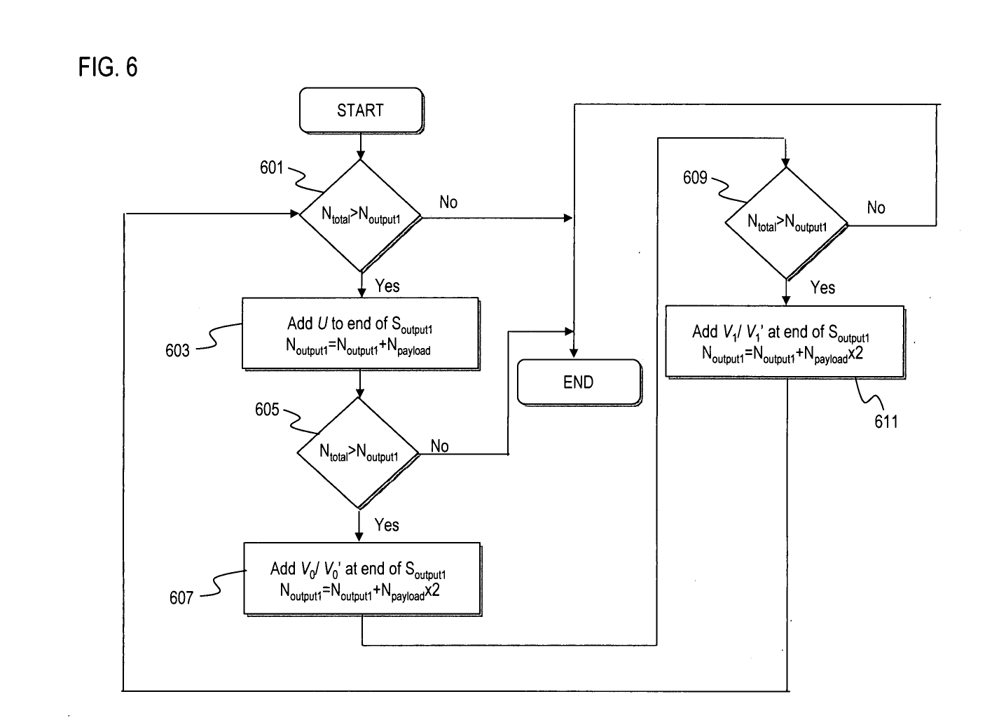

FIG. 6 is a flowchart of a process for providing subblock repetition, in accordance with an embodiment of the invention. The subblock repetition stage 402 is used to repeat the subblocks 501 once the symbols have been reordered in stage 401. By way of example, letting Nₜₒₜₐₗ, 3840×n be the total number of binary symbols; these symbols can be transmitted in n=1, 2, or 3 slots for the packet, as specified in, for example, C30-20040823-060. The expansion is described below.

In step 601, if Nₜₒₜₐₗ is larger than Nₒᵤₜₚᵤₜ₁ the output sequence Sₒᵤₜₚᵤₜ₁ is expanded, in which the subsequence U is added at the end of Sₒᵤₜₚᵤₜ₁, and Nₒᵤₜₚᵤₜ₁=Nₒᵤₜₚᵤₜ₁+N_{payload} (step 603). In step 605, the process again determines whether Nₜₒₜₐₗ>Nₒᵤₜₚᵤₜ₁, if true, the subsequence V₀/V₀′ is added at the end of Sₒᵤₜₚᵤₜ₁, and Nₒᵤₜₚᵤₜ₁=Nₒᵤₜₚᵤₜ₁+N_{payload}×2 as in step 607.

Next, in step 609, if Nₜₒₜₐₗ>Nₒᵤₜₚᵤₜ₁′, the subsequence V₁/V₁′ is added at the end of Sₒᵤₜₚᵤₜ₁, and Nₒᵤₜₚᵤₜ₁=Nₒᵤₜₚᵤₜ₁+N_{payload}×2, as in step 611. The steps 601 through 611 are repeated to form a new Sₒᵤₜₚᵤₜ₁ until Nₜₒₜₐₗ≦Nₒᵤₜₚᵤₜ₁.

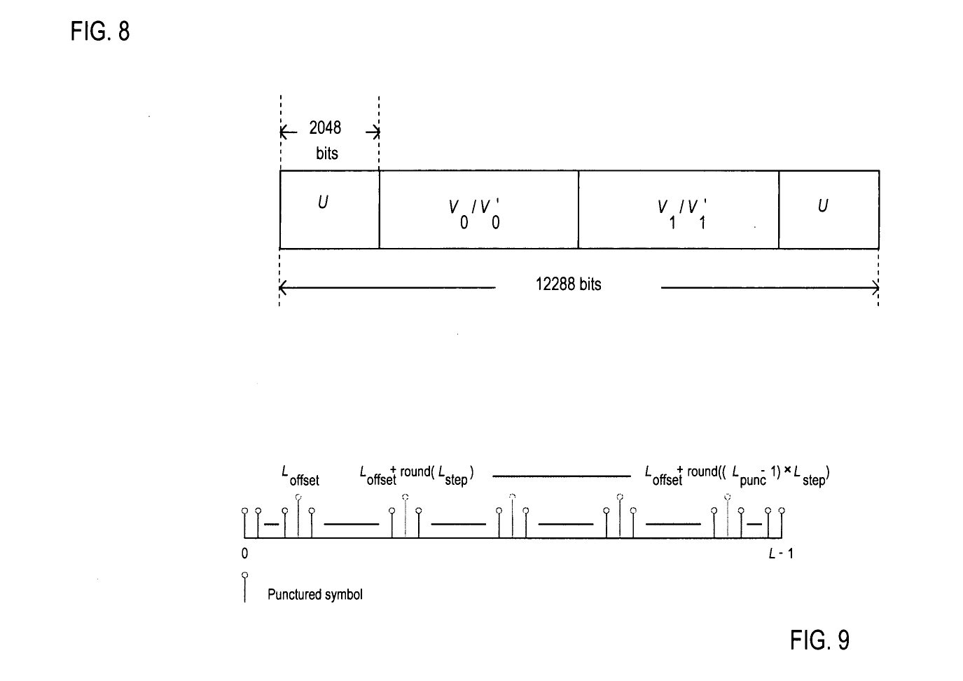

It is noted that for the MCS in Table 1, subblock repetition is performed for the case of 2048 payload transmitted in 3-slot duration—shown in FIG. 8 (subblock repetition for 2 k payload in 3 slots). In this case, Sₒᵤₜₚᵤₜ₁ includes four subsequences: U subsequence, followed by V₀/V₀′ subsequence, followed by V₁/V₁′ subsequence, and followed by another U subsequence. Nₒᵤₜₚᵤₜ₁=6*2048=12288.

After this subblock repetition stage, Nₜₒₜₐₗ≦Nₒᵤₜₚᵤₜ₁, Nₒᵤₜₚᵤₜ₁ is equal to 5 N_{payload}, or 6 N_{payload} (for the case of 2 k, 3 slots). It is noted that Nₜₒₜₐₗ=3840×n, for n=1, 2, or 3 slots.

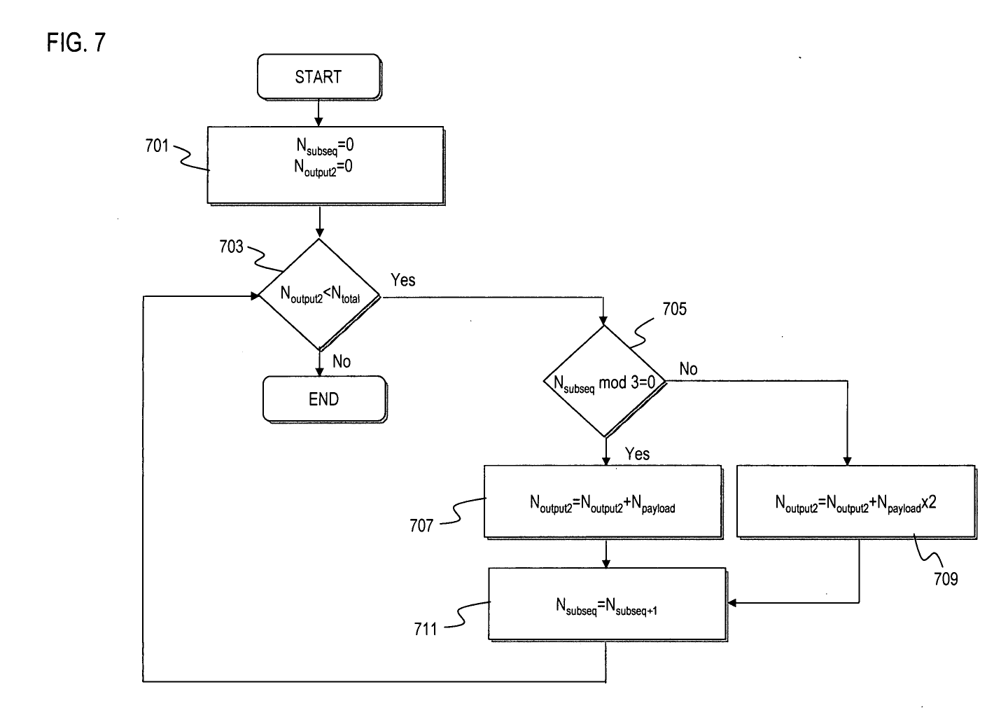

FIG. 7 is a flowchart of a process for providing sequence selection and punctuation, in accordance with an embodiment of the invention. The output of the sequence selection and punctuation stage 405, Sₒᵤₜₚᵤₜ₂ can comprise, in an exemplary embodiment, the first (N_{subseq}−1) subsequences (with subsequences indices 0, 1, 2, . . . , N_{subseq}−2) of Sₒᵤₜₚᵤₜ₁, and the punctured (N_{subseq}−1)-th subsequence of Sₒᵤₜₚᵤₜ₁, where N_{subseq} is defined in the following steps.

In step 701, initialization of N_{subseq}=0 and Nₒᵤₜₚᵤₜ₂=0 is performed. Next, in step 703, the process determines whether Nₒᵤₜₚᵤₜ₂<Nₜₒₜₐₗ. If Nₒᵤₜₚᵤₜ₂<Nₜₒₜₐₗ, then Nₒᵤₜₚᵤₜ₂ and N_{subseq} can be updated as follows. If N_{subseq} mod 3 is equal to 0 (step 705), Nₒᵤₜₚᵤₜ₂=Nₒᵤₜₚᵤₜ₂+N_{payload} (step 707), otherwise, Nₒᵤₜₚᵤₜ₂=Nₒᵤₜₚᵤₜ₂+N_{payload}×2 (step 709). In step 711, the process sets N_{subseq}=N_{subseq}+1. Steps 705-711 are repeated until Nₒᵤₜₚᵤₜ₂≧Nₜₒₜₐₗ.

A puncture of the (N_{subseq}−1)-th subsequence is shown in FIG. 9, according to one embodiment of the present invention. The punctured (N_{subseq}−1)-th subsequence of Sₒᵤₜₚᵤₜ₁, which is denoted by S_{punc}, is obtained by the following procedure (and illustrated in FIG. 9). It is assumed that L is the length of the (N_{subseq}−1)-th subsequence of Sₒᵤₜₚᵤₜ₁. If the (N_{subseq}−1)-th subsequence is U, L=N_{payload}; otherwise, L=N_{payload}×2. Also, L_{punc} denotes the length of S_{punc}, which is equal to Nₜₒₜₐₗ−(Nₒᵤₜₚᵤₜ₂−L). Further, the following is defined: Lₛₜₑₚ=L/L_{punc}, and L_{offset}=└Lₛₜₑₚ/2┘, where └x┘ indicates the largest integer smaller than or equal to x. The i-th symbol of S_{punc}, i=0, 1, 2, . . . , L_{punc}−1, is the (L_{offset}+round(i×Lₛₜₑₚ))-th symbol of the (N_{subseq}−1)-th subsequence of Sₒᵤₜₚᵤₜ₁.

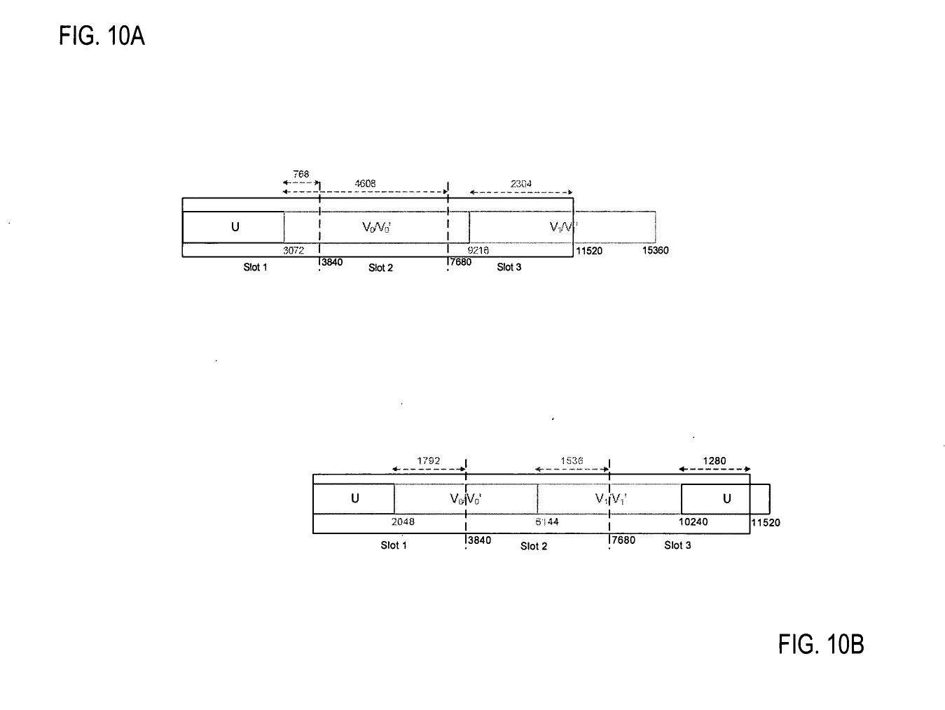

FIGS. 10A and 10B are diagrams of exemplary payload constructions utilized in the process of FIG. 4, according to an embodiment of the invention. In particular, FIG. 10A shows the construction of Sₒᵤₜₚᵤₜ₂ for 3 k payload, and FIG. 10B shows the construction of Sₒᵤₜₚᵤₜ₂ for 2 k payload. Table 3 summarizes the construction of Sₒᵤₜₚᵤₜ₂, according to one embodiment:

TABLE 3

| MCS | Tx Format | Nₒᵤₜₚᵤₜ₁ | Sₒᵤₜₚᵤₜ₁ | Nₜₒₜₐₗ | N_{subseq} | Nₒᵤₜₚᵤₜ₂ | Sₒᵤₜₚᵤₜ₂ |
|---|---|---|---|---|---|---|---|
| 1 | 2k, 3 slots | 12288 | UV₀/V₀′V₁/V₁′U | 11520 | 4 | 12288 | UV₀/V₀′V₁/V₁′ + 1280 systematic bits uniformly |
| | | | | | | | punctured over U |
| 2 | 2k, 2 slots | 10240 | UV₀/V₀′V₁/V₁′ | 7680 | 3 | 10240 | UV₀/V₀′ + 1536 parity bits uniformly punctured over V₁/V₁′ |
| 3 | 2k, 1 slot | 10240 | UV₀/V₀′V₁/V₁′ | 3840 | 2 | 6144 | U + 1792 parity bits uniformly punctured over V₀/V₀′ |
| 4 | 3k, 3 slots | 15360 | UV₀/V₀′V₁/V₁′ | 11520 | 3 | 15360 | UV₀/V₀′ + 2304 parity bits uniformly punctured over V₁/V₁′ |
| 5 | 3k, 2 slots | 15360 | UV₀/V₀′V₁/V₁′ | 7680 | 2 | 9216 | U + 4608 parity bits uniformly punctured over V₀/V₀′ |
| 6 | 3k, 1 slot | 15360 | UV₀/V₀′V₁/V₁′ | 3840 | 2 | 9216 | U + 768 parity bits uniformly punctured over V₀/V₀′ |

As an example, for a 3 k payload and 3 slots, Nₒᵤₜₚᵤₜ₁=5*3072=15360. Sₒᵤₜₚᵤₜ₁ includes U subsequence, followed by V₀/V₀′ subsequence, and followed by V₁/V₁′ subsequence. Nₜₒₜₐₗ=3840*3=11520, N_{subseq}=3, Nₒᵤₜₚᵤₜ₂=15360. Sₒᵤₜₚᵤₜ₂ includes U subsequence, followed by V₀/V₀′ subsequence, and followed by 2304 parity bits uniformly punctured over V₁/V₁′ subsequence.

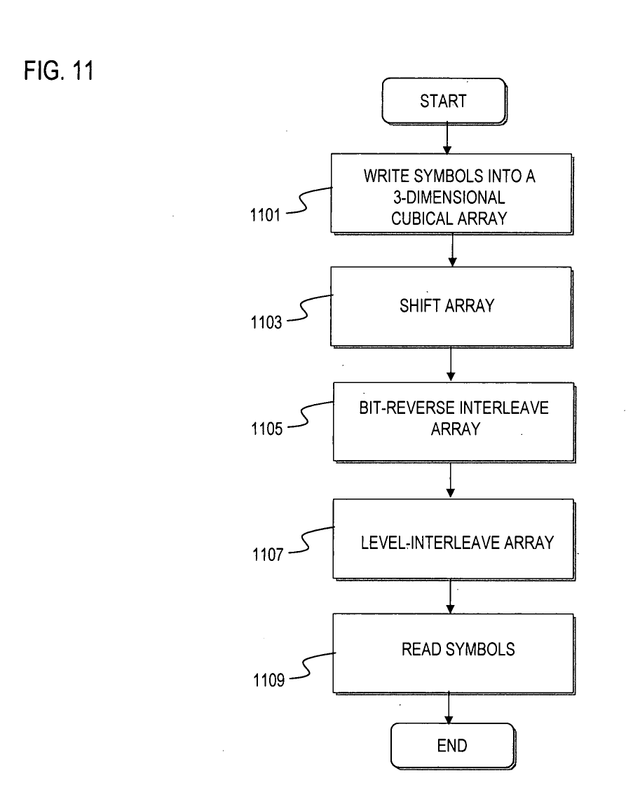

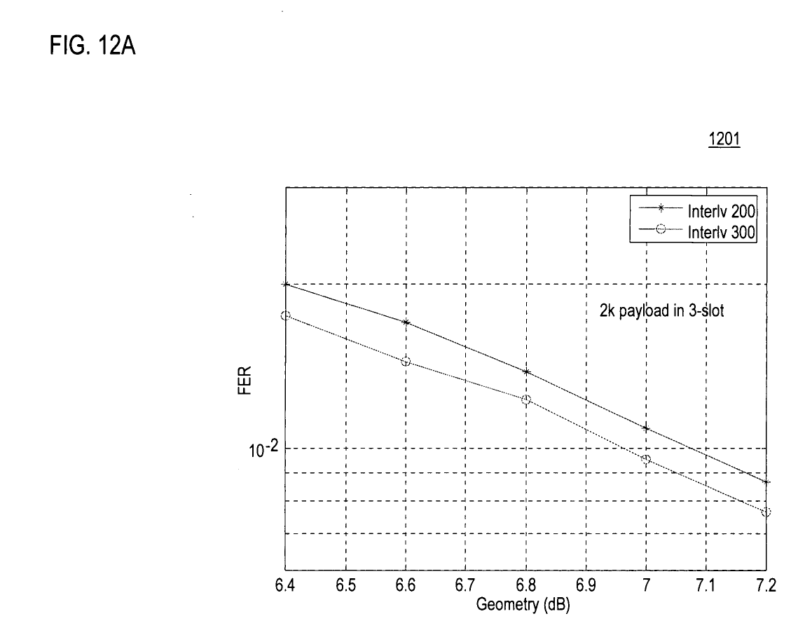

FIG. 11 is a flowchart of a process for matrix interleaving, in accordance with an embodiment of the invention. The sequence Sₒᵤₜₚᵤₜ₂ is interleaved by a single matrix interleaver; in one embodiment, this approach is similar to that specified, for example, in TSG-C.S0024-IS-856 (which is incorporated herein by reference in its entirety). The sequence of interleaver output symbols, in an exemplary embodiment, can be generated by the following procedure.

As seen in the figure, the Nₜₒₜₐₗ symbols of sequence Sₒᵤₜₚᵤₜ₂ as in step 1101, are written into a 3-dimensional cubical array with R rows, C≡2^{m} columns, and L levels. Symbols are written into the 3-dimensional array with level-index incrementing first, followed by column-index, followed by row-index. Next, the array is shifted, per step 1103. That is, the linear array of R symbols, at the c-th column and l-th level, is end-around-shifted by (c×L+l)mod R.

Next, the linear array of C symbols, at each given level and row, is bit-reverse interleaved (e.g., based on column index), per step 1105. Thereafter, level-interleaving is performed, as in step 1107. According to one embodiment, the linear array of L symbols, at each given row and column, is level-interleaved (based on level index) as follows. The L symbols are written into a 2-dimensional level-matrix with p rows and q columns. The symbols are written into the level-matrix with row-index incrementing first, followed by column-index. Additionally, the symbols from the level-matrix is read out with column-index incrementing first, followed by row-index. In step 1109, the symbols from the cubical array is read out with row-index incrementing first, followed by column-index, followed by level-index.

It is noted the matrix interleaver parameters depend on the number of transmission slots n, and are shown in Table 4 below.

TABLE 4

| n | R | M | L | p | q |
|---|---|---|---|---|---|
| 1 | 4 | 6 | 15 | 3 | 5 |
| 2 | 4 | 7 | 15 | 3 | 5 |
| 3 | 4 | 6 | 45 | 5 | 9 |

Let M denote the number of code symbols that can be transmitted in one slot (M=3840 for 320 tone format, M=5184 for 360 tone format). In the case of the 320 tone format (M=3840) with RS3 (5 k payload), the first 2M symbols are subjected to matrix interleaving with R=4 rows, C=128 columns and L=15 levels as specified in Table 5. The next M symbols are subjected to matrix interleaving with R=4 rows, C=64 columns and L=15 levels.

For RS1, the next M symbols are subjected to matrix interleaving with R=4 rows, C=64 columns and L=15 levels as specified below. For RS2, the next (5N−2M=2560) symbols are subjected to matrix interleaving with R=4 rows, C=128 columns and L=5 levels as specified in C.S00024-A.

In the case of 360 tone format (M=5184), the first M symbols are subjected to matrix interleaving with R=4 rows, C=16 columns and L=81 levels (per Table 5). The next M symbols are subjected to matrix interleaving with R=4 rows, C=16 columns and L=81 levels. For RS4, the next (3N−2M=1920) symbols are subjected to matrix interleaving with R=4 rows, C=32 columns and L=15 levels. For RS5, the next (5N−2M=4992) symbols are subjected to matrix interleaving with R=4 rows, C=32 columns and L=39 levels.

TABLE 5

| L | P | q |
|---|---|---|
| 15 | 3 | 5 |
| 81 | 9 | 9 |
| 39 | 3 | 13 |

In an alternative embodiment, the channel interleaving scheme follows that described in the Appendix.

FIGS. 12A-12F are graphs (1201-1211) showing the performance of the puncturer/channel interleaver of FIG. 3. The performance comparison of the channel interleaver 300 of FIG. 3 with the EBCMCS channel interleaver 200 of FIG. 2. It can be see that in all cases, the channel interleaver 300 outperforms the EBCMCS channel interleaver 200, especially for the case of 2 k payload transmitted in 1-slot, where the gain is up to 1 dB. Additionally, the interleaver 300 advantageously can be implemented without much complexity. Table 6, below, lists the transmission scenarios:

TABLE 6

| GRAPH | PAYLOAD AND SLOT |
|---|---|
| 1201 | 2k payload in 3-slot |
| 1203 | 2k payload in 2-slot |
| 1205 | 2k payload in 1-slot |
| 1207 | 3k payload in 3-slot |
| 1209 | 3k payload in 2-slot |
| 1211 | 3k payload in 1-slot |

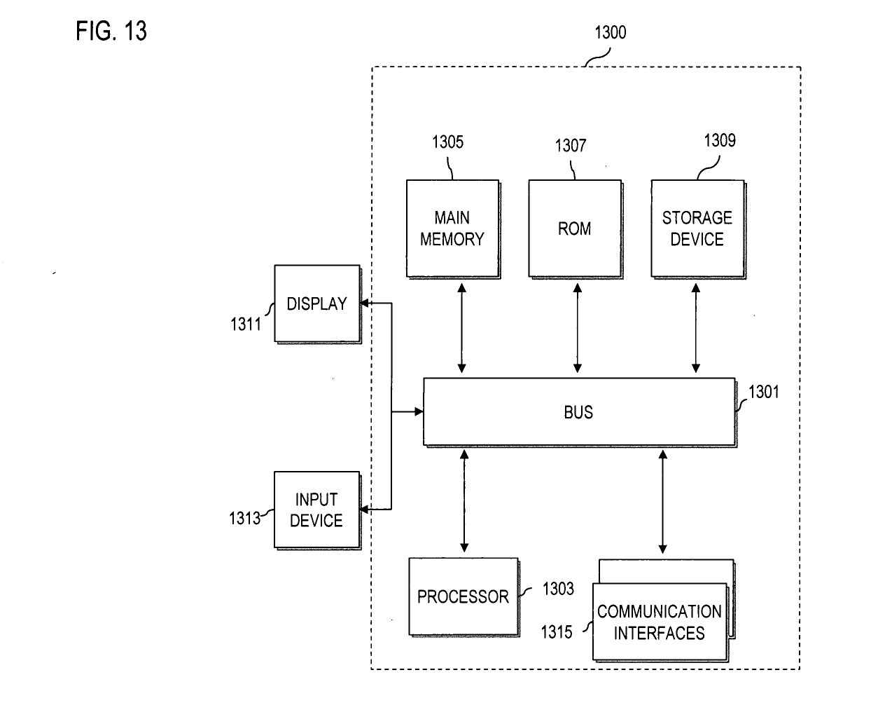

One of ordinary skill in the art would recognize that the processes for supporting channel interleaving and signal transmission may be implemented via software, hardware (e.g., general processor, Digital Signal Processing (DSP) chip, an Application Specific Integrated Circuit (ASIC), Field Programmable Gate Arrays (FPGAs), etc.), firmware, or a combination thereof. Such exemplary hardware for performing the described functions is detailed below with respect to FIG. 13.

FIG. 13 illustrates exemplary hardware upon which various embodiments of the invention can be implemented. A computing system 1300 includes a bus 1301 or other communication mechanism for communicating information and a processor 1303 coupled to the bus 1301 for processing information. The computing system 1300 also includes main memory 1305, such as a random access memory (RAM) or other dynamic storage device, coupled to the bus 1301 for storing information and instructions to be executed by the processor 1303. Main memory 1305 can also be used for storing temporary variables or other intermediate information during execution of instructions by the processor 1303. The computing system 1300 may further include a read only memory (ROM) 1307 or other static storage device coupled to the bus 1301 for storing static information and instructions for the processor 1303. A storage device 1309, such as a magnetic disk or optical disk, is coupled to the bus 1301 for persistently storing information and instructions.

The computing system 1300 may be coupled via the bus 1301 to a display 1311, such as a liquid crystal display, or active matrix display, for displaying information to a user. An input device 1313, such as a keyboard including alphanumeric and other keys, may be coupled to the bus 1301 for communicating information and command selections to the processor 1303. The input device 1313 can include a cursor control, such as a mouse, a trackball, or cursor direction keys, for communicating direction information and command selections to the processor 1303 and for controlling cursor movement on the display 1311.

According to various embodiments of the invention, the processes described herein can be provided by the computing system 1300 in response to the processor 1303 executing an arrangement of instructions contained in main memory 1305. Such instructions can be read into main memory 1305 from another computer-readable medium, such as the storage device 1309. Execution of the arrangement of instructions contained in main memory 1305 causes the processor 1303 to perform the process steps described herein. One or more processors in a multi-processing arrangement may also be employed to execute the instructions contained in main memory 1305. In alternative embodiments, hard-wired circuitry may be used in place of or in combination with software instructions to implement the embodiment of the invention. In another example, reconfigurable hardware such as Field Programmable Gate Arrays (FPGAs) can be used, in which the functionality and connection topology of its logic gates are customizable at run-time, typically by programming memory look up tables. Thus, embodiments of the invention are not limited to any specific combination of hardware circuitry and software.

The computing system 1300 also includes at least one communication interface 1315 coupled to bus 1301. The communication interface 1315 provides a two-way data communication coupling to a network link (not shown). The communication interface 1315 sends and receives electrical, electromagnetic, or optical signals that carry digital data streams representing various types of information. Further, the communication interface 1315 can include peripheral interface devices, such as a Universal Serial Bus (USB) interface, a PCMCIA (Personal Computer Memory Card International Association) interface, etc.

The processor 1303 may execute the transmitted code while being received and/or store the code in the storage device 1309, or other non-volatile storage for later execution. In this manner, the computing system 1300 may obtain application code in the form of a carrier wave.

The term “computer-readable medium” as used herein refers to any medium that participates in providing instructions to the processor 1303 for execution. Such a medium may take many forms, including but not limited to non-volatile media, volatile media, and transmission media. Non-volatile media include, for example, optical or magnetic disks, such as the storage device 1309. Volatile media include dynamic memory, such as main memory 1305. Transmission media include coaxial cables, copper wire and fiber optics, including the wires that comprise the bus 1301. Transmission media can also take the form of acoustic, optical, or electromagnetic waves, such as those generated during radio frequency (RF) and infrared (IR) data communications. Common forms of computer-readable media include, for example, a floppy disk, a flexible disk, hard disk, magnetic tape, any other magnetic medium, a CD-ROM, CDRW, DVD, any other optical medium, punch cards, paper tape, optical mark sheets, any other physical medium with patterns of holes or other optically recognizable indicia, a RAM, a PROM, and EPROM, a FLASH-EPROM, any other memory chip or cartridge, a carrier wave, or any other medium from which a computer can read.

Various forms of computer-readable media may be involved in providing instructions to a processor for execution. For example, the instructions for carrying out at least part of the invention may initially be borne on a magnetic disk of a remote computer. In such a scenario, the remote computer loads the instructions into main memory and sends the instructions over a telephone line using a modem. A modem of a local system receives the data on the telephone line and uses an infrared transmitter to convert the data to an infrared signal and transmit the infrared signal to a portable computing device, such as a personal digital assistant (PDA) or a laptop. An infrared detector on the portable computing device receives the information and instructions borne by the infrared signal and places the data on a bus. The bus conveys the data to main memory, from which a processor retrieves and executes the instructions. The instructions received by main memory can optionally be stored on storage device either before or after execution by processor.

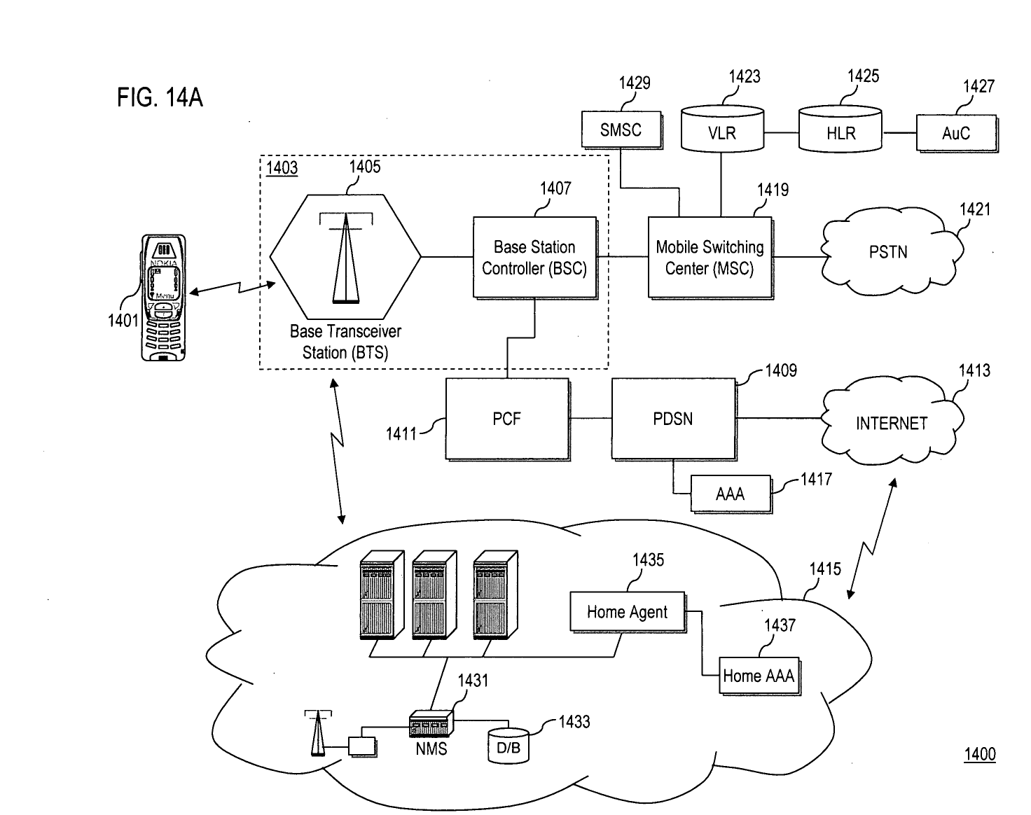

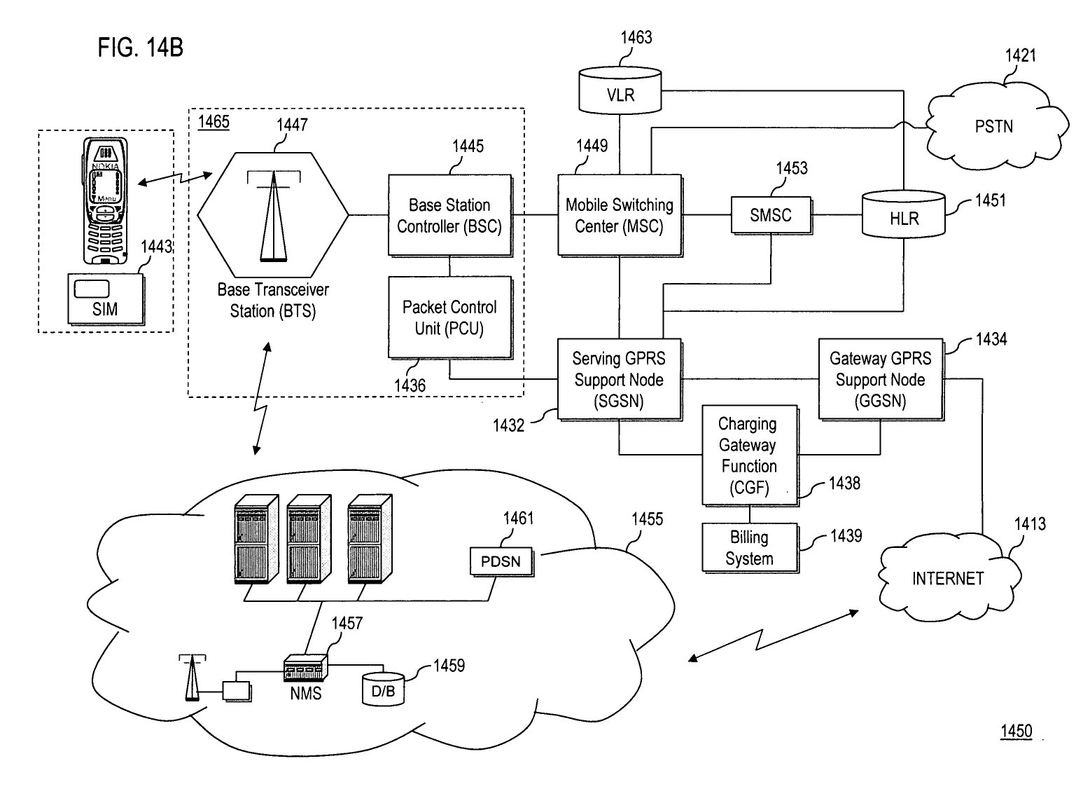

FIGS. 14A and 14B are diagrams of different cellular mobile phone systems capable of supporting various embodiments of the invention. FIGS. 14A and 14B show exemplary cellular mobile phone systems each with both mobile station (e.g., handset) and base station having a transceiver installed (as part of a Digital Signal Processor (DSP)), hardware, software, an integrated circuit, and/or a semiconductor device in the base station and mobile station). By way of example, the radio network supports Second and Third Generation (2G and 3G) services as defined by the International Telecommunications Union (ITU) for International Mobile Telecommunications 2000 (IMT-2000). For the purposes of explanation, the carrier and channel selection capability of the radio network is explained with respect to a cdma2000 architecture. As the third-generation version of IS-95, cdma2000 is being standardized in the Third Generation Partnership Project 2 (3GPP2).

A radio network 1400 includes mobile stations 1401 (e.g., handsets, terminals, stations, units, devices, or any type of interface to the user (such as “wearable” circuitry, etc.)) in communication with a Base Station Subsystem (BSS) 1403. According to one embodiment of the invention, the radio network supports Third Generation (3G) services as defined by the International Telecommunications Union (ITU) for International Mobile Telecommunications 2000 (IMT-2000).

In this example, the BSS 1403 includes a Base Transceiver Station (BTS) 1405 and Base Station Controller (BSC) 1407. Although a single BTS is shown, it is recognized that multiple BTSs are typically connected to the BSC through, for example, point-to-point links. Each BSS 1403 is linked to a Packet Data Serving Node (PDSN) 1409 through a transmission control entity, or a Packet Control Function (PCF) 1411. Since the PDSN 1409 serves as a gateway to external networks, e.g., the Internet 1413 or other private consumer networks 1415, the PDSN 1409 can include an Access, Authorization and Accounting system (AAA) 1417 to securely determine the identity and privileges of a user and to track each user's activities. The network 1415 comprises a Network Management System (NMS) 1431 linked to one or more databases 1433 that are accessed through a Home Agent (HA) 1435 secured by a Home AAA 1437.

Although a single BSS 1403 is shown, it is recognized that multiple BSSs 1403 are typically connected to a Mobile Switching Center (MSC) 1419. The MSC 1419 provides connectivity to a circuit-switched telephone network, such as the Public Switched Telephone Network (PSTN) 1421. Similarly, it is also recognized that the MSC 1419 may be connected to other MSCs 1419 on the same network 1400 and/or to other radio networks. The MSC 1419 is generally collocated with a Visitor Location Register (VLR) 1423 database that holds temporary information about active subscribers to that MSC 1419. The data within the VLR 1423 database is to a large extent a copy of the Home Location Register (HLR) 1425 database, which stores detailed subscriber service subscription information. In some implementations, the HLR 1425 and VLR 1423 are the same physical database; however, the HLR 1425 can be located at a remote location accessed through, for example, a Signaling System Number 7 (SS7) network. An Authentication Center (AuC) 1427 containing subscriber-specific authentication data, such as a secret authentication key, is associated with the HLR 1425 for authenticating users. Furthermore, the MSC 1419 is connected to a Short Message Service Center (SMSC) 1429 that stores and forwards short messages to and from the radio network 1400.

During typical operation of the cellular telephone system, BTSs 1405 receive and demodulate sets of reverse-link signals from sets of mobile units 1401 conducting telephone calls or other communications. Each reverse-link signal received by a given BTS 1405 is processed within that station. The resulting data is forwarded to the BSC 1407. The BSC 1407 provides call resource allocation and mobility management functionality including the orchestration of soft handoffs between BTSs 1405. The BSC 1407 also routes the received data to the MSC 1419, which in turn provides additional routing and/or switching for interface with the PSTN 1421. The MSC 1419 is also responsible for call setup, call termination, management of inter-MSC handover and supplementary services, and collecting, charging and accounting information. Similarly, the radio network 1400 sends forward-link messages. The PSTN 1421 interfaces with the MSC 1419. The MSC 1419 additionally interfaces with the BSC 1407, which in turn communicates with the BTSs 1405, which modulate and transmit sets of forward-link signals to the sets of mobile units 1401.

As shown in FIG. 14B, the two key elements of the General Packet Radio Service (GPRS) infrastructure 1450 are the Serving GPRS Supporting Node (SGSN) 1432 and the Gateway GPRS Support Node (GGSN) 1434. In addition, the GPRS infrastructure includes a Packet Control Unit PCU (1336) and a Charging Gateway Function (CGF) 1438 linked to a Billing System 1439. A GPRS the Mobile Station (MS) 1441 employs a Subscriber Identity Module (SIM) 1443.

The PCU 1436 is a logical network element responsible for GPRS-related functions such as air interface access control, packet scheduling on the air interface, and packet assembly and re-assembly. Generally the PCU 1436 is physically integrated with the BSC 1445; however, it can be collocated with a BTS 1447 or a SGSN 1432. The SGSN 1432 provides equivalent functions as the MSC 1449 including mobility management, security, and access control functions but in the packet-switched domain. Furthermore, the SGSN 1432 has connectivity with the PCU 1436 through, for example, a Frame Relay-based interface using the BSS GPRS protocol (BSSGP). Although only one SGSN is shown, it is recognized that that multiple SGSNs 1431 can be employed and can divide the service area into corresponding routing areas (RAs). A SGSN/SGSN interface allows packet tunneling from old SGSNs to new SGSNs when an RA update takes place during an ongoing Personal Development Planning (PDP) context. While a given SGSN may serve multiple BSCs 1445, any given BSC 1445 generally interfaces with one SGSN 1432. Also, the SGSN 1432 is optionally connected with the HLR 1451 through an SS7-based interface using GPRS enhanced Mobile Application Part (MAP) or with the MSC 1449 through an SS7-based interface using Signaling Connection Control Part (SCCP). The SGSN/HLR interface allows the SGSN 1432 to provide location updates to the HLR 1451 and to retrieve GPRS-related subscription information within the SGSN service area. The SGSN/MSC interface enables coordination between circuit-switched services and packet data services such as paging a subscriber for a voice call. Finally, the SGSN 1432 interfaces with a SMSC 1453 to enable short messaging functionality over the network 1450.

The GGSN 1434 is the gateway to external packet data networks, such as the Internet 1413 or other private customer networks 1455. The network 1455 comprises a Network Management System (NMS) 1457 linked to one or more databases 1459 accessed through a PDSN 1461. The GGSN 1434 assigns Internet Protocol (IP) addresses and can also authenticate users acting as a Remote Authentication Dial-In User Service host. Firewalls located at the GGSN 1434 also perform a firewall function to restrict unauthorized traffic. Although only one GGSN 1434 is shown, it is recognized that a given SGSN 1432 may interface with one or more GGSNs 1433 to allow user data to be tunneled between the two entities as well as to and from the network 1450. When external data networks initialize sessions over the GPRS network 1450, the GGSN 1434 queries the HLR 1451 for the SGSN 1432 currently serving a MS 1441.

The BTS 1447 and BSC 1445 manage the radio interface, including controlling which Mobile Station (MS) 1441 has access to the radio channel at what time. These elements essentially relay messages between the MS 1441 and SGSN 1432. The SGSN 1432 manages communications with an MS 1441, sending and receiving data and keeping track of its location. The SGSN 1432 also registers the MS 1441, authenticates the MS 1441, and encrypts data sent to the MS 1441.

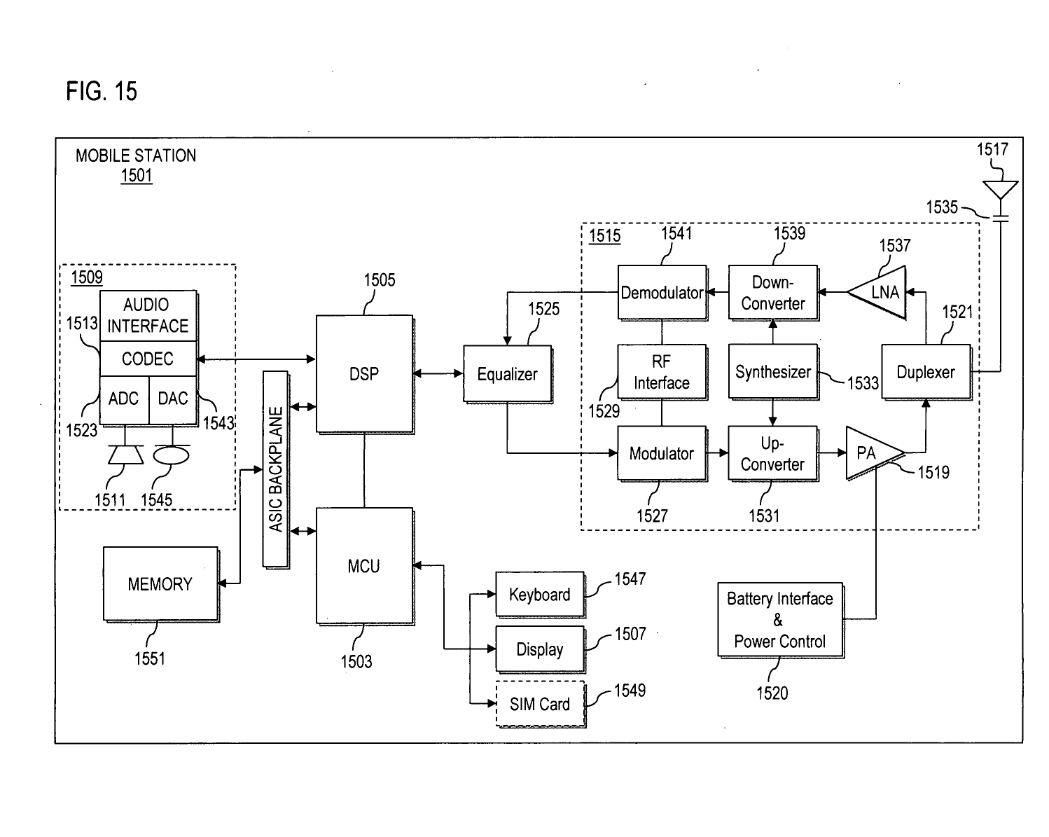

FIG. 15 is a diagram of exemplary components of a mobile station (e.g., handset) capable of operating in the systems of FIGS. 14A and 14B, according to an embodiment of the invention. Generally, a radio receiver is often defined in terms of front-end and back-end characteristics. The front-end of the receiver encompasses all of the Radio Frequency (RF) circuitry whereas the back-end encompasses all of the base-band processing circuitry. Pertinent internal components of the telephone include a Main Control Unit (MCU) 1503, a Digital Signal Processor (DSP) 1505, and a receiver/transmitter unit including a microphone gain control unit and a speaker gain control unit. A main display unit 1507 provides a display to the user in support of various applications and mobile station functions. An audio function circuitry 1509 includes a microphone 1511 and microphone amplifier that amplifies the speech signal output from the microphone 1511. The amplified speech signal output from the microphone 1511 is fed to a coder/decoder (CODEC) 1513.

A radio section 1515 amplifies power and converts frequency in order to communicate with a base station, which is included in a mobile communication system (e.g., systems of FIG. 14A or 14B), via antenna 1517. The power amplifier (PA) 1519 and the transmitter/modulation circuitry are operationally responsive to the MCU 1503, with an output from the PA 1519 coupled to the duplexer 1521 or circulator or antenna switch, as known in the art. The PA 1519 also couples to a battery interface and power control unit 1520.

In use, a user of mobile station 1501 speaks into the microphone 1511 and his or her voice along with any detected background noise is converted into an analog voltage. The analog voltage is then converted into a digital signal through the Analog to Digital Converter (ADC) 1523. The control unit 1503 routes the digital signal into the DSP 1505 for processing therein, such as speech encoding, channel encoding, encrypting, and interleaving. In the exemplary embodiment, the processed voice signals are encoded, by units not separately shown, using the cellular transmission protocol of Code Division Multiple Access (CDMA), as described in detail in the Telecommunication Industry Association's TIA/EIA/IS-95-A Mobile Station-Base Station Compatibility Standard for Dual-Mode Wideband Spread Spectrum Cellular System; which is incorporated herein by reference in its entirety.

The encoded signals are then routed to an equalizer 1525 for compensation of any frequency-dependent impairments that occur during transmission though the air such as phase and amplitude distortion. After equalizing the bit stream, the modulator 1527 combines the signal with a RF signal generated in the RF interface 1529. The modulator 1527 generates a sine wave by way of frequency or phase modulation. In order to prepare the signal for transmission, an up-converter 1531 combines the sine wave output from the modulator 1527 with another sine wave generated by a synthesizer 1533 to achieve the desired frequency of transmission. The signal is then sent through a PA 1519 to increase the signal to an appropriate power level. In practical systems, the PA 1519 acts as a variable gain amplifier whose gain is controlled by the DSP 1505 from information received from a network base station. The signal is then filtered within the duplexer 1521 and optionally sent to an antenna coupler 1535 to match impedances to provide maximum power transfer. Finally, the signal is transmitted via antenna 1517 to a local base station. An automatic gain control (AGC) can be supplied to control the gain of the final stages of the receiver. The signals may be forwarded from there to a remote telephone which may be another cellular telephone, other mobile phone or a land-line connected to a Public Switched Telephone Network (PSTN), or other telephony networks.

Voice signals transmitted to the mobile station 1501 are received via antenna 1517 and immediately amplified by a low noise amplifier (LNA) 1537. A down-converter 1539 lowers the carrier frequency while the demodulator 1541 strips away the RF leaving only a digital bit stream. The signal then goes through the equalizer 1525 and is processed by the DSP 1005. A Digital to Analog Converter (DAC) 1543 converts the signal and the resulting output is transmitted to the user through the speaker 1545, all under control of a Main Control Unit (MCU) 1503—which can be implemented as a Central Processing Unit (CPU) (not shown).

The MCU 1503 receives various signals including input signals from the keyboard 1547. The MCU 1503 delivers a display command and a switch command to the display 1507 and to the speech output switching controller, respectively. Further, the MCU 1503 exchanges information with the DSP 1505 and can access an optionally incorporated SIM card 1549 and a memory 1551. In addition, the MCU 1503 executes various control functions required of the station. The DSP 1505 may, depending upon the implementation, perform any of a variety of conventional digital processing functions on the voice signals. Additionally, DSP 1505 determines the background noise level of the local environment from the signals detected by microphone 1511 and sets the gain of microphone 1511 to a level selected to compensate for the natural tendency of the user of the mobile station 1501.

The CODEC 1513 includes the ADC 1523 and DAC 1543. The memory 1551 stores various data including call incoming tone data and is capable of storing other data including music data received via, e.g., the global Internet. The software module could reside in RAM memory, flash memory, registers, or any other form of writable storage medium known in the art. The memory device 1551 may be, but not limited to, a single memory, CD, DVD, ROM, RAM, EEPROM, optical storage, or any other non-volatile storage medium capable of storing digital data.

An optionally incorporated SIM card 1549 carries, for instance, important information, such as the cellular phone number, the carrier supplying service, subscription details, and security information. The SIM card 1549 serves primarily to identify the mobile station 1501 on a radio network. The card 1549 also contains a memory for storing a personal telephone number registry, text messages, and user specific mobile station settings.

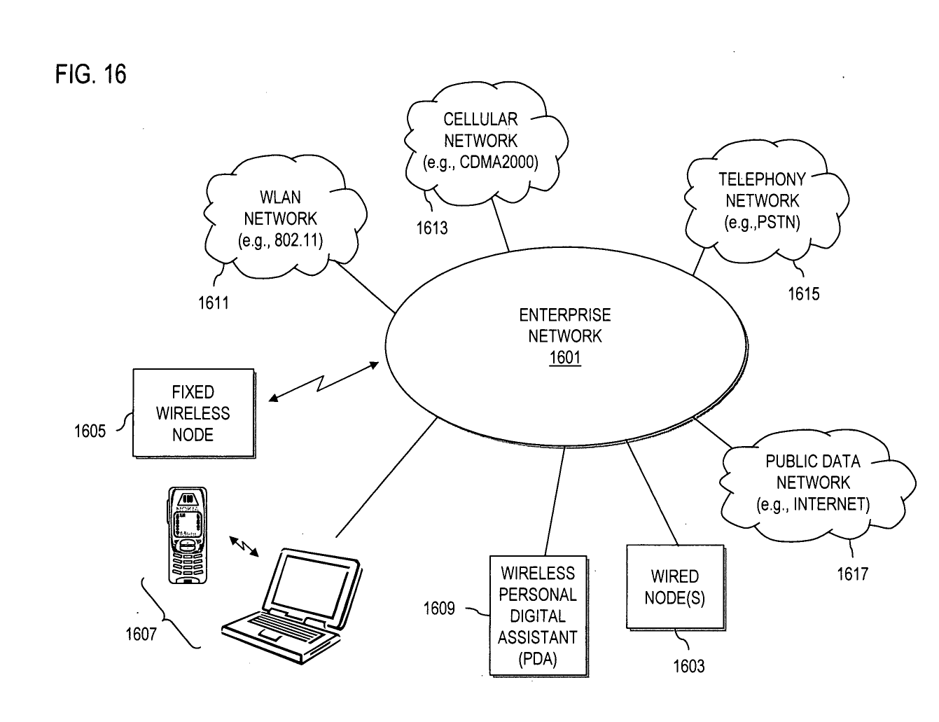

FIG. 16 shows an exemplary enterprise network, which can be any type of data communication network utilizing packet-based and/or cell-based technologies (e.g., Asynchronous Transfer Mode (ATM), Ethernet, IP-based, etc.). The enterprise network 1601 provides connectivity for wired nodes 1603 as well as wireless nodes 1605-1609 (fixed or mobile), which are each configured to perform the processes described above. The enterprise network 1601 can communicate with a variety of other networks, such as a WLAN network 1611 (e.g., IEEE 802.11), a cdma2000 cellular network 1613, a telephony network 1616 (e.g., PSTN), or a public data network 1617 (e.g., Internet).

While the invention has been described in connection with a number of embodiments and implementations, the invention is not so limited but covers various obvious modifications and equivalent arrangements, which fall within the purview of the appended claims. Although features of the invention are expressed in certain combinations among the claims, it is contemplated that these features can be arranged in any combination and order.

### APPENDIX

The sequence of N_{enc} binary symbols at the output of the scrambler is interleaved with a Channel Interleaver. Channel interleaving includes a Symbol Reordering stage followed by a Matrix Interleaving stage. The packet length, N_{data} (including data and tail bits) is expressed as N_{data}=R×C, where R and C are positive integers. The channel interleaver is described in terms of the parameters R, C, D, M₁, M₂, M₃, L₁, L₂, and L₃ which depend on the rate set corresponding to the broadcast packet and are given in Table 7 for Fixed Mode and in Table 8 for Variable Mode.

TABLE 7

| Rate | | | | | | |
|---|---|---|---|---|---|---|
| Set | N_{data} | R | C | D | M₁, M₂, M₃ | L₁, L₂, L₃ |
| 1 | 3072 | 4 | 768 | 4 | 192, 1152, 576 | 960, 960, 960 |
| 2 | 2048 | 4 | 512 | 2 | 448, 1024, 384 | 960, 960, 640 |
| 3 | 5120 | 4 | 1280 | 4 | 640, 1600, 0 | 1920, 960, 960 |
| 4 | 4096 | 4 | 1024 | 8 | 272, 1472, 0 | 1296, 1296, 480 |
| 5 | 3072 | 4 | 768 | 1 | 528, 1536, 288 | 1296, 1296, 1248 |
| 6 | 5120 | 4 | 1280 | 4 | 640, 1600, 0 | 1920, 960, 960 |

TABLE 8

| Rate | | | | | | |
|---|---|---|---|---|---|---|
| Set | N_{data} | R | C | D | M₁, M₂, M₃ | L₁, L₂, L₃ |
| 1 | 3072 | 4 | 768 | 4 | 192, 1488, 1248 | 960, 1296, 1296 |
| 2 | 2048 | 4 | 512 | 2 | 448, 1024, 720 | 960, 1296, 304 |
| 3 | 5120 | 4 | 1280 | 4 | 640, 1721, 0 | 1920, 1291, 629 |
| 4 | 4096 | 4 | 1024 | 8 | 272, 1640, 0 | 1296, 1440, 336 |
| 5 | 3072 | 4 | 768 | 1 | 528, 1536, 432 | 1296, 1440, 1104 |
| 6 | 5120 | 4 | 1280 | 4 | 640, 1721, 0 | 1920, 1291, 629 |

The scrambled turbo encoder data and tail output symbols generated with the rate-1/5 encoder (corresponding to Rate Sets 1, 2, and 5) is reordered according to the following procedure:

1. All of the scrambled data and tail turbo encoder output symbols is demultiplexed into five sequences denoted U, V₀, V₁, V′₀, and V′₁. The scrambled encoder output symbols is sequentially distributed from the U sequence to the V′₁ sequence with the first scrambled encoder output symbol going to the U sequence, the second to the V₀ sequence, the third to the V₁ sequence, the fourth to the V′₀ sequence, the fifth to the V′₁ sequence, the sixth to the U sequence, etc.

2. The U, V₀, V₁, V′₀, and V′₁ sequences is ordered according to UV₀V′₀V₁V′₁. That is, the U sequence of symbols is first and the V′₁ sequence of symbols is last.

The scrambled turbo encoder data and tail output symbols generated with the rate-1/3 encoder (corresponding to Rate Sets 3, 4, and 6) is reordered according to the following procedure:

1. All of the scrambled data and tail turbo encoder output symbols is demultiplexed into three sequences denoted U, V₀, and V′₀. The scrambled encoder output symbols is sequentially distributed from the U sequence to the V′₀ sequence with the first scrambled encoder output symbol going to the U sequence, the second to the V₀ sequence, the third to the V′₀ sequence, the fourth to the U sequence, etc.

2. The U, V₀, and V′₀ sequences is ordered according to UV₀V′₀. That is, the U sequence of symbols is first and the V′₀ sequence of symbols is last.

The matrix interleaving operation is carried out in the following steps:

1. The N_{data} symbols of the U sequence are written into a 2-dimensional rectangular array W with R rows and C columns, where N_{data}=R×C. Symbols are written into the 2-dimensional array with column-index incrementing first, followed by the row-index. In other words, the i^{th} incoming symbol, where 0≦i<N_{data} goes into the r^{th} row and c^{th} column, where r=[i/C] and c=i mod C and the ranges of r and c indices are given by 0≦r<R and 0≦c<C.

2. The linear array of R symbols, at the c^{th} column of the rectangular array W is end-around shifted by c mod R. In other words, W[r][c] is moved to W[(r+c)modR][c] for all 0≦r<R and 0≦c<C.

3. The N_{data} symbols of the V₀ sequence, followed by the N_{data} symbols of the V′₀ sequence are written into a 2-dimensional rectangular array W₀ with R rows and 2C columns. Symbols are written into the 2-dimensional array with column-index incrementing first, followed by the row-index. In other words, the i^{th} incoming symbol, where 0≦i<2N_{data} goes into the r^{th} row and c^{th} column, where r=[i/2C] and c=i mod 2C and the ranges of r and c indices are given by 0≦r<R and 0≦c<2C.

4. The linear array of R symbols, at the c^{th} column of the rectangular array W₀ is end-around shifted by [c/D] mod R. In other words, W₀[r][c] is moved to W₀[(r+[c/D]) mod R][c] for all 0≦r<R and 0≦c<2C.

5. The two dimensional array W₀ is transformed to the two dimensional array W₀[ ][σ₀] (in other words, the linear array of 2C symbols at each row of the rectangular array W₀ is interleaved based on column-index c by moving column σ₀[c] of the rectangular array W₀ to column c for all 0≦c<2C), where the vector σ₀ can be obtained by the following procedure: Let S₁, S₂, and S₃ be ordered sets of integers defined as follows (note that the sets S₁, S₂, S₃ defined by the following procedure partition the set of integers {i|0≦i<2C}):

S₁={[C/M₁]+[i*(2C/M₁)+0.5]|0≦i<M₁}

S₂={[C/M₂]+[i*(2C/M₂)+0.5]|0≦i<M₂}−S₁

S₃={i|0≦i<2C}−S₁−S₂.

The elements of the vector σ₀ [c] as c ranges from 0 to 2C−1 are obtained by first taking all the elements of the ordered set S₁ (that is the first M₁ elements of the linear array σ₀ come from the ordered set S₁), and then all the elements of S₂, and finally all the elements of S₃ in the order the elements appear in the respective ordered sets.

6. If the encoder is of rate-1/5, then a 2-dimensional rectangular array W₁ with R rows and 2C columns is constructed by following the same procedure described in Step 3 by replacing all occurrences of the rectangular array W₀ and the sequences V₀ and V′₀ by the rectangular array W₁ and the sequences V₁ and V′₁, respectively. If the encoder is of rate-1/3, then Steps 7 and 8 below are skipped.

7. Each column of the rectangular array W₁ is end-around shifted by applying the procedure described in Step 4 with the array W₀ replaced by the array W₁.

8. The two dimensional array W₁ is transformed to the two dimensional array W₁[ ][σ₁] (in other words, the linear array of 2C symbols at each row of the rectangular array W₁ is interleaved based on column-index c by moving column ([c] of the rectangular array W₁ to column c for all 0≦c<2C), where the vector σ₁ can be obtained by the following procedure: Let S₄ and S₅ be ordered sets of integers defined as follows (note that the sets S₄ and S₅ defined by the following procedure partition the set of integers {i|0≦i<2C}):

S₄={[C/M₃]+[i*(2C/M₃)+0.5]|0≦i<M₃}

S₅={i|0≦i<2C}−S₄.

The elements of the vector σ₁[c] as c ranges from 0 to 2C−1 are obtained by first taking all the elements of the ordered set S₄ (that is, the first M₃ elements of the linear array a come from S₄), and then all the elements of S₅ in the order the elements appear in the respective ordered sets.

9. If the encoder is of rate-1/5, then a rectangular array Z of R rows and 5C columns will be formed by juxtaposing the rectangular arrays W, W₀, and W₁, in that order, that is, Z=[W W₀ W₁]. If the encoder is of rate-1/3, then a rectangular array Z of R rows and 3C columns will be formed by juxtaposing the rectangular arrays W and W₀, in that order, that is, Z=[W W₀].

10. The columns of the rectangular array Z are interleaved by the column index c by the following procedure: For columns 0≦c<L₁, each column c is moved to column (79 c) mod L₁. For columns L₁≦c<L₁+L₂, each column c is moved to column L₁+(79(c−L₁)) mod L₂. For columns L₁+L₂≦c<L₁+L₂+L₃, each column c is moved to column L₁+L₂+(79(c−L₁−L₂)) mod L₃. The remaining columns of the rectangular array Z, if any, are not interleaved.

11. The N_{enc} symbols of the rectangular array Z are read out with row-index incrementing first, followed by the column-index. In other words, the i^{th} output symbol, where 0≦i<N_{enc}, comes from the r^{th} row and c^{th} column of the rectangular array Z where c=[i/R] and r=i mod R and the ranges of r and c indices are given by 0≦r<R and 0≦c<C′ where the number of columns C′ of the rectangular array Z is given by C′=5C if the encoder is of rate-1/5 and C′=3C if the encoder is of rate-1/3. Note also that N_{enc}=R×C′.

What is claimed is:

1. A method comprising:
receiving a plurality of symbols;
partitioning the symbols into a plurality of subblocks, the subblocks forming a plurality of subsequences;
generating a first output sequence from the subsequences;
selecting the subsequences of the first output sequence and puncturing the first output sequence to generate a second output sequence; and
interleaving the second output sequence.

2. A method according to claim 1, wherein the subblocks are denoted by S, P₀, P₁, P₀′ and P₁′, the method further comprising:
sequentially distributing the symbols into the subblocks in the following order: S, P₀, P₁, P₀′ and P₁′.

3. A method according to claim 2, wherein the subsequences are denoted by U, V₀/V₀′, and V₁/V₁′, and the first output sequence includes the subsequences U, V₀/V₀′, and V₁/V₁′.

4. A method according to claim 3, wherein Nₜₒₜₐₗ is the total number of symbols and Nₒᵤₜₚᵤₜ₁ is the number of symbols in the first output sequence, the method further comprising:
determining whether Nₜₒₜₐₗ is larger than Nₒᵤₜₚᵤₜ₁; expanding the first output sequence Sₒᵤₜₚᵤₜ₁ by adding the subsequence U at the end of Sₒᵤₜₚᵤₜ₁ based on the determination of whether Nₜₒₜₐₗ is larger than Nₒᵤₜₚᵤₜ₁;
updating Nₒᵤₜₚᵤₜ₁ as follows Nₒᵤₜₚᵤₜ₁=Nₒᵤₜₚᵤₜ₁+N_{payload}, wherein N_{payload} represents the number of symbols in a payload;
determining whether Nₜₒₜₐₗ is larger than Nₒᵤₜₚᵤₜ₁; and
adding the subsequence V₀/V₀′ at the end of Sₒᵤₜₚᵤₜ₁, and setting Nₒᵤₜₚᵤₜ₁=Nₒᵤₜₚᵤₜ₁+N_{payload}×2 based on the determination whether Nₜₒₜₐₗ is larger than Nₒᵤₜₚᵤₜ₁.

5. A method according to claim 3, wherein Nₜₒₜₐₗ is the total number of symbols and Nₒᵤₜₚᵤₜ₂ is the number of symbols in the second output sequence that is denoted as Sₒᵤₜₚᵤₜ₂ the second output sequence comprises a first (N_{subseq}−1) subsequences (with subsequences indices 0, 1, 2, . . . , N_{subseq}−2) of Sₒᵤₜₚᵤₜ₁, and the punctured (N_{subseq}−1)-th subsequence of Sₒᵤₜₚᵤₜ₁ wherein N_{subseq} is the number of symbols in a subsequence, the method further comprising:
determines whether Nₒᵤₜₚᵤₜ₂<Nₜₒₜₐₗ;
updating Nₒᵤₜₚᵤₜ₂ and N_{subseq} based on the determination of whether Nₒᵤₜₚᵤₜ₂<Nₜₒₜₐₗ, the updating step including,
setting Nₒᵤₜₚᵤₜ₂=Nₒᵤₜₚᵤₜ₂+N_{payload}, if N_{subseq} mod 3 is equal to 0, and
setting Nₒᵤₜₚᵤₜ₂=Nₒᵤₜₚᵤₜ₂+N_{payload}×2 if N_{subseq} mod 3 is not equal to 0;
setting N_{subseq}=N_{subseq}+1; and
repeating the steps of determining whether Nₒᵤₜₚᵤₜ₂<Nₜₒₜₐₗ, updating Nₒᵤₜₚᵤₜ₂ and N_{subseq}, and
setting N_{subseq}=N_{subseq}+1 until Nₒᵤₜₚᵤₜ₂≧Nₜₒₜₐₗ.

6. A method according to claim 5, further comprising:
writing the Nₜₒₜₐₗ symbols of sequence Sₒᵤₜₚᵤₜ₂ into a 3-dimensional cubical array with R rows, C≡2^{m} columns, and L levels, wherein R, C and L are integers;
shifting the array;
bit-reverse interleaving the array;
level-interleaving the array; and
reading out the symbols from the cubical array is read out with row-index incrementing first, followed by column-index, followed by level-index.

7. A method according to claim 6, further comprising:
writing the L symbols into a 2-dimensional level-matrix with p rows and q columns by row-index incrementing, followed by column-index.

8. A method according to claim 1, wherein the symbols are Turbo encoded using an outer Reed-Solomon (RS) code.

9. A method according to claim 1, wherein a signal is generated based on the interleaved symbols for transmission over a spread spectrum system.

10. An apparatus comprising:
a symbol reordering module configured to receive a plurality of symbols and to partition the symbols into a plurality of subblocks;
a subblock repetition module configured to repeat the corresponding subblocks, the subblocks forming a plurality of subsequences, wherein the subblock repetition module being further configured to generate a first output sequence from the subsequences;
a sequence selection and punctuation module configured to select the subsequences of the first output sequence and to puncture the first output sequence to generate a second output sequence; and
a matrix interleaving module configured to interleave the second output sequence.

11. An apparatus according to claim 10, wherein the subblocks are denoted by S, P₀, P₁, P₀′ and P₁′, the symbol reordering module being further configured to sequentially distribute the symbols into the subblocks in the following order: S, P₀, P₁, P₀′ and P₁′.

12. An apparatus according to claim 11, wherein the subsequences are denoted by U, V₀/V₀′, and V₁/V₁′, and the first output sequence includes the subsequences U, V₀/V₀′, and V₁/V₁′.

13. An apparatus according to claim 12, wherein Nₜₒₜₐₗ is the total number of symbols and Nₒᵤₜₚᵤₜ₁ is the number of symbols in the first output sequence, the subblock repetition module being further configured to determine whether Nₜₒₜₐₗ is larger than Nₒᵤₜₚᵤₜ₁ to expand the first output sequence Sₒᵤₜₚᵤₜ₁ by adding the subsequence U at the end of Sₒᵤₜₚᵤₜ₁ based on the determination of whether Nₜₒₜₐₗ is larger than Nₒᵤₜₚᵤₜ₁ and to update Nₒᵤₜₚᵤₜ₁ as follows Nₒᵤₜₚᵤₜ₁=Nₒᵤₜₚᵤₜ₁+N_{payload}, wherein N_{payload} represents the number of symbols in a payload, the subblock repetition module being further configured to determine whether Nₜₒₜₐₗ is larger than Nₒᵤₜₚᵤₜ₁, to add the subsequence V₀/V₀′ at the end of Sₒᵤₜₚᵤₜ₁, and to set Nₒᵤₜₚᵤₜ₁=Nₒᵤₜₚᵤₜ₁+N_{payload}×2 based on the determination whether Nₜₒₜₐₗ is larger than Nₒᵤₜₚᵤₜ₁.

14. An apparatus according to claim 12, wherein Nₜₒₜₐₗ is the total number of symbols and Nₒᵤₜₚᵤₜ₂ is the number of symbols in the second output sequence that is denoted as Sₒᵤₜₚᵤₜ₂ the second output sequence comprises a first (N_{subseq}−1) subsequences (with subsequences indices 0, 1, 2, . . . , N_{subseq}−2) of Sₒᵤₜₚᵤₜ₁, and the punctured (N_{subseq}−1)-th subsequence of Sₒᵤₜₚᵤₜ₁, wherein N_{subseq} is the number of symbols in a subsequence, the sequence selection and punctuation module being further configured to determine whether Nₒᵤₜₚᵤₜ₂<Nₜₒₜₐₗ, to update Nₒᵤₜₚᵤₜ₂ and N_{subseq} based on the determination of whether Nₒᵤₜₚᵤₜ₂<Nₜₒₜₐₗ, wherein the update includes setting Nₒᵤₜₚᵤₜ₂=Nₒᵤₜₚᵤₜ₂+N_{payload}, if N_{subseq} mod 3 is equal to 0, and setting Nₒᵤₜₚᵤₜ₂=Nₒᵤₜₚᵤₜ₂+N_{payload}×2 if N_{subseq} mod 3 is not equal to 0, wherein the sequence selection and punctuation module further configured to set N_{subseq}=N_{subseq}+1.

15. An apparatus according to claim 14, wherein the matrix interleaving module is further configured to write the Nₜₒₜₐₗ symbols of sequence Sₒᵤₜₚᵤₜ₂ into a 3-dimensional cubical array with R rows, C≡2^{m} columns, and L levels, wherein R, C and L are integers, the matrix interleaving module being further configured to shift the array, to bit-reverse interleave the array, to level-interleave the array, and to read out the symbols from the cubical array is read out with row-index incrementing first, followed by column-index, followed by level-index.

16. An apparatus according to claim 15, wherein the matrix interleaving module is configured to write the L symbols into a 2-dimensional level-matrix with p rows and q columns by row-index incrementing, followed by column-index.

17. An apparatus according to claim 10, wherein the symbols are Turbo encoded using an outer Reed-Solomon (RS) code.

18. An apparatus according to claim 10, wherein a signal is generated based on the interleaved symbols for transmission over a spread spectrum system.

19. A system comprising the apparatus of claim 10.

20. A method comprising:
encoding a plurality of signals as encoded symbols;
scrambling the encoded symbols;
interleaving the scrambled symbols, the step of interleaving including,
reordering the encoded symbols, wherein the encoded symbols are sequentially distributed into a plurality of subblocks,
performing repetition of the subblocks, wherein the subblocks are formed into subsequences,
performing selection and punctuation of the subsequences, and
applying a matrix interleaving scheme to the symbols associated with the selected and punctured subsequences;
modulating the interleaved symbols as modulated signals; and
transmitting the modulated signals.

21. A method according to claim 20, wherein the subblocks are denoted by S, P₀, P₁, P₀′ and P₁′, the method further comprising:
sequentially distributing the symbols into the subblocks in the following order: S, P₀, P₁, P₀′ and P₁′.

22. A method according to claim 21, wherein the subsequences are denoted by U, V₀/V₀′, and V₁/V₁′, and the first output includes the subsequences U, V₀/V₀′, and V₁/V₁′.

23. A method according to claim 22, wherein Nₜₒₜₐₗ is the total number of symbols and Nₒᵤₜₚᵤₜ₁ is the number of symbols in the first output sequence, the method further comprising:
determining whether Nₜₒₜₐₗ is larger than Nₒᵤₜₚᵤₜ₁;
expanding the first output sequence Sₒᵤₜₚᵤₜ₁ by adding the subsequence U at the end of S based on the determination of whether Nₜₒₜₐₗ is larger than Nₒᵤₜₚᵤₜ₁;
updating Nₒᵤₜₚᵤₜ₁ as follows Nₒᵤₜₚᵤₜ₁=Nₒᵤₜₚᵤₜ₁+N_{payload}, wherein N_{payload} represents the number of symbols in a payload;
determining whether Nₜₒₜₐₗ is larger than Nₒᵤₜₚᵤₜ₁; and
adding the subsequence V₀/V₀′ at the end of Sₒᵤₜₚᵤₜ₁, and setting Nₒᵤₜₚᵤₜ₁=Nₒᵤₜₚᵤₜ₁+N_{payload}×2 based on the determination whether Nₜₒₜₐₗ is larger than Nₒᵤₜₚᵤₜ₁.

24. A method according to claim 22, wherein Nₜₒₜₐₗ is the total number of symbols and Nₒᵤₜₚᵤₜ₂ is the number of symbols in the second output sequence that is denoted as Sₒᵤₜₚᵤₜ₂ the second output sequence comprises a first (N_{subseq}−1) subsequences (with subsequences indices 0, 1, 2, . . . , N_{subseq}−2) of Sₒᵤₜₚᵤₜ₁, and the punctured (N_{subseq}−1)-th subsequence of Sₒᵤₜₚᵤₜ₁, wherein N_{subseq} is the number of symbols in a subsequence, the method further comprising:
determines whether Nₒᵤₜₚᵤₜ₂<Nₜₒₜₐₗ;
updating Nₒᵤₜₚᵤₜ₂ and N_{subseq} based on the determination of whether Nₒᵤₜₚᵤₜ₂<Nₜₒₜₐₗ, the updating step including,
setting Nₒᵤₜₚᵤₜ₂=Nₒᵤₜₚᵤₜ₂+N_{payload}, if N_{subseq} mod 3 is equal to 0, and
setting Nₒᵤₜₚᵤₜ₂=Nₒᵤₜₚᵤₜ₂+N_{payload}×2 if N_{subseq} mod 3 is not equal to 0;
setting N_{subseq}=N_{subseq}+1; and
repeating the steps of determining whether Nₒᵤₜₚᵤₜ₂<Nₜₒₜₐₗ, updating Nₒᵤₜₚᵤₜ₂ and N_{subseq}, and setting N_{subseq}=N_{subseq}+1 until Nₒᵤₜₚᵤₜ₂≧Nₜₒₜₐₗ.

25. A method according to claim 24, further comprising:
writing the Nₜₒₜₐₗ symbols of sequence Sₒᵤₜₚᵤₜ₂ into a 3-dimensional cubical array with R rows, C≡2^{m} columns, and L levels, wherein R, C and L are integers;
shifting the array;
bit-reverse interleaving the array;
level-interleaving the array; and
reading out the symbols from the cubical array is read out with row-index incrementing first, followed by column-index, followed by level-index.

26. A method according to claim 25, further comprising:
writing the L symbols into a 2-dimensional level-matrix with p rows and q columns by row-index incrementing, followed by column-index.

27. A method according to claim 20, wherein the symbols are Turbo encoded using an outer Reed-Solomon (RS) code.

28. A method according to claim 20, wherein a signal is generated based on the interleaved symbols for broadcast transmission or multicast transmission over a spread spectrum system.

29. A system comprising:
an encoder configured to encode a plurality of signals as encoded symbols;
a scrambler configured to scramble the encoded symbols;
a channel interleaver configured to interleave the scrambled symbols, the channel interleaver being configured to perform the steps of,
reordering the encoded symbols, wherein the encoded symbols are sequentially distributed into a plurality of subblocks,
performing repetition of the subblocks, wherein the subblocks are formed into subsequences,
performing selection and punctuation of the subsequences, and
applying a matrix interleaving scheme to the symbols associated with the selected and punctured subsequences; and
a modulator configured to modulate the interleaved symbols as modulated signals.

30. A system according to claim 29, further comprising:
a numeric key pad configured to receive user input; and
a display configured to display the user input.

31. A system according to claim 29, further comprising:
means for transmitting the modulated signals using spread spectrum.
